(19) United States
(12) Patent Application Publication
(10) Pub. No.: US 2025/0160369 A1
(43) Pub. Date: May 22, 2025

(54) Artificial Dehydrated Pizzle of Edible Pet Chew

(71) Applicant: Shanghai Sunlight Innov Trading Co., Ltd., Shanghai (CN)

(72) Inventor: Guangqiang Xu, Shanghai (CN)

(21) Appl. No.: 19/026,715

(22) Filed: Jan. 17, 2025

Related U.S. Application Data
(63) Continuation-in-part of application No. 18/215,822, filed on Jun. 28, 2023, now Pat. No. 12,245,617.
Application No. 18/215,822 is a continuation of application No. 17/481,302, filed on Sep. 21, 2021, now abandoned.
Application No. 17/481,302 is a continuation of application No. 16/190,118, filed on Nov. 13, 2018, now Pat. No. 11,122,820.
(63) Continuation-in-part of application No. 17/931,540, filed on Sep. 12, 2022, now Pat. No. 12,268,226.
Application No. 17/931,540 is a continuation-in-part of application No. 17/481,302, filed on Sep. 21, 2021, now abandoned.
Application No. 17/481,302 is a continuation-in-part of application No. 17/478,986, filed on Sep. 20, 2021, now Pat. No. 12,161,088.
Application No. 17/478,986 is a continuation-in-part of application No. 16/190,118, filed on Nov. 13, 2018, now Pat. No. 11,122,820.
Application No. 16/190,118 is a continuation-in-part of application No. 15/680,721, filed on Aug. 18, 2017, now Pat. No. 10,159,266.
Application No. 15/680,721 is a continuation-in-part of application No. 14/059,420, filed on Oct. 21, 2013, now Pat. No. 9,770,044.
Application No. 14/059,420 is a continuation-in-part of application No. 13/052,113, filed on Mar. 21, 2011, now Pat. No. 8,776,728.
Application No. 16/190,118 is a continuation-in-part of application No. 14/289,610, filed on May 28, 2014, now Pat. No. 9,044,039.
Application No. 14/289,610 is a continuation-in-part of application No. 13/052,113, filed on Mar. 21, 2011, now Pat. No. 8,776,728.

(51) Int. Cl. A23K 40/25; A23K 10/26; A23K 10/30; A23K 20/158; A23K 50/40; A23K 50/42

(52) U.S. Cl. CPC A23K 40/25; A23K 10/26; A23K 10/30; A23K 20/158; A23K 50/40; A23K 50/42

(57) ABSTRACT

An edible pet chew includes an artificial dried pizzle component formed from a composition material imitating existing dried real pizzle products (such as bully stick, bully rings, bully spiral, etc.), serving as an alternative to the dried real pizzle products. The imitation includes the structure, and/or appearance, and/or size, and/or color, and/or texture, and/or flavor, and/or durability of dried real pizzle (traditional bully stick). The artificial dried pizzle component may be an extrudate made of a collagen-based material (optimally the collagen-based material is rawhide free).

### CROSS REFERENCE OF RELATED APPLICATION

This application is a Continuation-in-par application of, and claims priority benefit to U.S. application Ser. No. 18/215,822 by Xu, entitled “ARTIFICIAL BUYLLY STICK OF EDIBLE PET CHEW”, filed on Jun. 28, 2023, which is a Continuation-in-par application of U.S. Application Ser. No. 17/481,302 by XU, entitled “ARTIFICIAL BULLY STICK OF EDIBLE PET CHEW,” filed Sep. 21, 2021, which is a continuation application of U.S. application Ser. No. 16/190,118 by XU, entitled “EDIBLE PET CHEW OF ARTIFICIAL BULLY STICK,” filed Nov. 13, 2018, now issued U.S. Pat. No. 11,122,820, which is a continuation-in-part of U.S. application Ser. No. 15/680,721 by XU, entitled “EDIBLE PET CHEW OF ARTIFICIAL BULLY STICK,” filed Aug. 18, 2017, now issued U.S. Pat. No. 10,159,266

This application is also a continuation-in-part application of U.S. application Ser. No. 17/931,540, filed on Sep. 12, 2022, Which is a Continuation-in-par application of U.S. application Ser. No. 17/478,986, filed on Sep. 20, 2021, which is a continuation-in-part application of U.S. application Ser. No. 16/190,118, filed on Nov. 12, 2018, now issued as U.S. Pat. No. 11,122,820, which is a continuation-in-part application of U.S. application Ser. No. 15/680,721, filed on Aug. 17, 2017, now issued as U.S. Pat. No. 10,159,266.

This application also claims priority to CN Application No. 201710697772.9 filed on Aug. 15, 2017.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT DISCLOSURE

### Field of Disclosure

The field of this disclosure relates to an edible pet chew, and more particularly to an artificial dehydrated pizzle (or artificial bully stick) of edible pet chew.

### Description of Related Arts

Domestic pets, primarily dogs, have an instinct to chew which keeps their teeth healthy, exercises their jaws and teeth and keeps teeth clean. “Pet chew” products have been introduced to the market for many years to accommodate that instinctive urge to chew in a healthy direction.

“Pet chews” are intended to be chewed by a pet/dog for an extended period of time before being digested. A great part of pet chew products on the market are dehydrated bovine pizzle (or traditional bully sticks) welcome very much by dogs and consumers, which are made of natural bovine penis. Generally, foreskin of bovine penis is removed, cleaned and then dehydrated by for example heating or freeze-drying. It enjoys an inherent “good palatability” and “durability (after dehydrating process)” which makes it an outstanding successful product in the trade.

U.S. application Ser. No. 13/858,592 by Shrestha, filed on Apr. 8, 2013, disclosed a pet chew including a hardened cheese and a dry animal tissue such as bully sticks attached to the cheese piece. And it also disclosed a kind of animal tissue puff such as bully puff. However, the bully sticks or bully puff it attempts to apply still refer to traditional bully stick (dehydrated bovine pizzle). It still is involved in the drawbacks of traditional bully stick as aforementioned.

U.S. Pat. No. 8,479,687 by Anderson, filed on Feb. 14, 2007, disclosed a pet chew with rawhide and traditional bully stick (or steer penis) woven together. Since it is still a traditional bully stick product (dehydrated pizzle), it suffers from the drawbacks of traditional bully stick aforementioned.

US patent application no. U.S. Pat. No. 8,074,609B2 by Grant Adkins, filed on Mar. 25, 2010, disclosed a rawhide pet chew with a traditional bully stick (dehydrated bovine pizzle) wrapped in. But since it is still a dehydrated bovine pizzle (traditional bully stick) product, it suffers from the drawbacks of traditional bully stick aforementioned.

U.S. Pat. No. 7,677,203 by Stern, filed on Nov. 21, 2006, disclosed a pet chew with a plant-based outer casing and a chewy edible material positioned within the casing.

U.S. application Ser. No. 14,295/009 by Doerr, filed on Jun. 3, 2014, disclosed a pet chew comprising an amylase filling and a collagen casing. Collagen casing in the trade or in a common sense refers to a type of thin, edible casings (sausage casing) made from animal collagen, primarily from the skin, bones, and connective tissues of cows or pigs. It serves as an alternative to traditional natural casings made from the intestines of animals.

Attention is also directed to U.S. Pat. No. 7,691,426 by Axelrod, filed on Jun. 9, 2006, disclosed an animal chew combining a rawhide member and edible resin one.

What is required is to provide a pet chew overcoming the drawbacks of dehydrated bovine pizzle (or traditional bully stick) of the prior arts.

### SUMMARY OF THE PRESENT DISCLOSURE

In some embodiments of the present disclosure, it is to provide an edible pet chew (pet treat) including an artificial dehydrated pizzle component formed from an extrudate produced by extrusion process. The extrusion process may typically be hot-melt-extrusion (HME) process or cold extrusion process alternatively. The extrusion process may be mono-extrusion or co-extrusion alternatively. In some embodiments of the present disclosure, it is to provide an edible pet chew (pet treat) including an artificial dehydrated pizzle component formed by injection process or rolling process.

In some embodiments of the present disclosure, it is to provide an edible pet chew (pet treat) free of rawhide. The presence of rawhide or rawhide sheet ingredient (either in original sheet form or ground form) in a pet chew or particularly in a component of a chew may bring the following drawbacks to the chew: A), Rawhide material does not have inherently-attractive flavor urging dogs to chew, which may not be helpful to the chew attraction. B), Manufacture of rawhide is a relatively unregulated industry. It may create pollution to the environment. C), The residues of chemicals such as NH₄CL, H₂O₂ and NaOH that are usually used in rawhide manufacture especially in an unregulated way may bring health jeopardy to dogs. D), Heavy metals may remain in finished products made of rawhide, which may harm dogs' health. E), Rawhide may not be easily digestible and end up causing unnecessary digestive discomfort.

In some embodiments of the present disclosure, it is to provide a pet chew (pet treat) including an artificial dehydrated pizzle component made of a composition material that is free of rawhide ingredient.

In some embodiments of the present disclosure, it is to provide an edible pet chew (pet treat) including an artificial dehydrated pizzle component formed from an extrudate made of a composition material. In at least one embodiment of these, the composition material is a thermoplastic one.

An embodiment of the present disclosure is to provide an edible pet chew serving as an alternative to existing dehydrated bovine pizzle (traditional bully stick) product by imitating/approximating the structure, and/or shape, and/or appearance, and/or size, and/or color, and/or texture, and/or flavor, and/or durability, and/or palatability of dehydrated bovine pizzle (traditional bully stick).

Another embodiment of the present disclosure is to provide an edible pet chew incorporating two existing popular products into a single product, where the two existing products are collagen-based product and dehydrated bovine pizzle (traditional bully stick) product. Another embodiment of the present disclosure is to provide an edible pet chew incorporating two existing popular products into a single product, where the two existing products are animal-skin-based (source of collagen) product and dehydrated bovine pizzle (traditional bully stick) product.

Another embodiment of the present disclosure is to provide an edible pet chew incorporating some features from two existing popular products into a single product, where the two existing products are extruded (or injection-molding-shaped) product and dehydrated bovine pizzle (traditional bully stick) product.

Another embodiment of the present disclosure is to provide an edible pet chew formed from a composition material.

An embodiment of the present disclosure is to provide an edible pet chew with an outer layer (or outer casing) component and an inner member, and the outer layer component is with good durability and strength, which imitates or approximates a feature of dehydrated bovine pizzle (traditional bully stick).

An embodiment of the present disclosure is to provide an Artificial Dehydrated Pizzle (or artificial bully stick) pet chew with an artificial dehydrated pizzle member formed from a single layer (or single piece) material that may not be involved in a separate outer layer segment or inner segment.

One embodiment of the present disclosure is to provide an Artificial Dehydrated Pizzle (or artificial bully stick) pet chew with an Artificial Dehydrated Pizzle (or artificial bully stick) member formed from a single layer (or single piece) extrudate or a multi-layer extrudate with bubbles existing internally in the chew or existing inside the chew.

Another embodiment of the present disclosure is to provide an edible pet chew having an artificial dehydrated pizzle component with a cross-section outline shape similar to that of a natural dehydrated bovine pizzle (bully sticks).

Another embodiment of the present disclosure is to provide an Artificial Dehydrated Pizzle (or artificial bully stick or Pizzle-like) pet chew which is significantly cheaper than dehydrated bovine pizzle (traditional bully stick).

Another embodiment of the present disclosure is to provide an Artificial dehydrated pizzle pet chew (or artificial bully stick pet chew) which is raw-material-acquisition comparatively hugely easier than dehydrated bovine pizzle (traditional bully stick).

An embodiment of the present disclosure is to provide an edible pet chew including an artificial dehydrated pizzle component as a whole (or the outer casing of the component alone) is made of a collagen-based composition material

An embodiment of the present disclosure is to provide an edible pet chew including an artificial dehydrated pizzle component with pizzle ingredient in the formula.

In some embodiments of the present disclosure, it is to provide a pet chew (pet treat) whose first ingredient (or number one proportion ingredient) by weight in the composition of the final end product as a whole is collagen, in which the pet chew includes an artificial dehydrated pizzle (artificial bully stick) component. In the present disclosure, when a material or ingredient is referred to as “first ingredient” or “number one proportion ingredient” in a specific formula or composition, it follows the rule that all the ingredients in the formula (composition) is listed in descending order of predominance by weight.

In some embodiments of the present disclosure, it is to provide a pet chew (pet treat) including an artificial dehydrated pizzle (artificial bully stick) component, in which the component is formed of a collagen-based composition material having a collagen constituent (or collagen ingredient, or naturally-collagen-rich material) as the first ingredient (or number one proportion ingredient) by weight in its recipe/formula/composition, in which the component in final product may be formed into an artificial dehydrated pizzle component having a groove running longitudinally on the surface.

In some embodiments of the present disclosure, it is to provide an edible pet chew including an artificial dehydrated pizzle component formed from a collagen-based composition and having a groove running longitudinally on the surface of the component in final end product, where the component is formed from an extrudate produced by extrusion process, and where the extrudate may be further shaped into final product configuration/shape/structure/form such as the shapes of a knotted bone, a twisted stick, a ring, a spiral, a spring, a curl, a pretzel knot, a knotted form, a kabob form, a dural-strand braid, a triple-strand braid, a stick and a braid.

In one aspect of the present disclosure, it is to provide an edible pet chew including an artificial dehydrated pizzle component formed from a collagen-based composition and having a groove running longitudinally on the surface of the component in final end product, where the component is formed from a mono-layered extrudate produced by extrusion (mono-extrusion) process, and where the extrudate may be further shaped into final product configuration/shape/structure/form such as the shapes of a knotted bone, a twisted stick, a ring, a spiral, a spring, a curl and a braid. In some embodiments, the mono-layered extrudate is in an ordinary tubular form having a groove on the surface. In some embodiments, the mono-layered extrudate is in a flat sheet form and further curved/rolled into a curved/rolled sheet form having a groove on the surface. In some embodiments, the mono-layered extrudate is inherently in a rolled/curved sheet form having a groove on the surface. In some embodiments, the mono-layered extrudate is in a “finned” tubular form having a groove on the surface.

In another aspect of the present disclosure, it is to provide an edible pet chew including an artificial dehydrated pizzle component formed from a collagen-based composition and having a groove running longitudinally on the surface of the component in final end product, where the component is formed from a multi-layered extrudate produced by extrusion (co-extrusion) process, and where the extrudate may be further shaped into final product configuration/shape/structure/form such as the shapes of a knotted bone, a twisted stick, a ring, a spiral, a spring, a curl and a braid. In some embodiments, the multi-layered extrudate with a groove on the surface has an outer layer in an ordinary tubular form and an inner layer. In some embodiments, the multi-layered extrudate with a groove on the surface has an outer layer in a curved/rolled sheet form and an inner layer. In some embodiments, the multi-layered extrudate with a groove on the surface has an outer layer in a “finned” tubular form and an inner layer.

These and other embodiments, features and advantages of the present disclosure will become apparent from the following detailed description, the accompanying drawings, and the appended claims.

### BRIEF DESCRIPTION OF THE DRAWINGS

FIG. 1 is a view of four Artificial Dehydrated/Dried Pizzle (or artificial bully stick, or say Pizzle-like) pet chews according to the disclosure in a stick configuration, with a cross-section outline shape like capital letter “B”, having an artificial dehydrated pizzle component formed from an extrudate formed by mono-extrusion.

FIG. 2 is a view of four Artificial Dehydrated/Dried Pizzle (or artificial bully stick, or say Pizzle-like) pet chews according to the disclosure in a stick configuration, with a cross-section outline shape like capital letter “B”, having an artificial dehydrated pizzle component formed from an extrudate formed by co-extrusion.

FIG. 3 is a view of an Artificial Dehydrated/Dried Pizzle (or artificial bully stick) pet chew according to the disclosure in a knotted bone shape.

FIG. 4 is a view of a pet chew according to the disclosure with three separate strands of Artificial Dehydrated/Dried Pizzle (or artificial bully stick) components, initially respectively being in a stick shape and finally being woven together to a braided structure.

FIG. 5 is a view of two Artificial Bully Stick (or say Bully-Stick-LIKE) pet chews according to the disclosure, one in a spiral (or, spring, or curl) configuration and the other in a braided configuration.

FIG. 6 is a view of an Artificial Bully Stick (or say Bully-Stick-LIKE) pet chew according to the disclosure in a ring configuration with a cross-section outline shape similar to capital letter “B”.

FIG. 7 is a view of three pieces of Artificial Bully Stick (or say Bully-Stick-LIKE) pet chews according to the disclosure in a stick configuration with a stick shape and/or surface texture in more natural irregularities.

FIG. 8 is a view of an Artificial Bully Stick (or say Bully-Stick-LIKE) pet chew according to the disclosure in a stick configuration with a cross-section outline shape like Arabic Numeral “8”, and with two hollow holes through the chew body.

FIG. 9 is a view of a kabob-formed pet chew according to the disclosure with a member of Artificial Dehydrated/Dried Pizzle (or artificial bully stick) 0901 and three ball-like members of composition 0911/0912/0913.

FIG. 10 is a view of an Artificial Dehydrated/Dried Pizzle (or artificial bully stick) pet chew according to the disclosure in a braided configuration with two pieces of beef-hide sheet and a piece of artificial bully stick member being woven together.

FIG. 11 shows 3 groups (totally 18) alternative cross-section outline shapes of a pet chew Artificial Dehydrated Pizzle component formed by co-extrusion according to the disclosure.

FIG. 12 shows 3 groups (totally 18) alternative cross-section outline shapes of a pet chew Artificial Dehydrated Pizzle component formed by mono-extrusion according to the disclosure.

FIG. 13 is a prior art, a view of a typical mono-extrusion extruder, a machine system for producing pet chew products.

FIG. 14 is a prior art, a view of a natural flesh of beef pizzle in a full length configuration, which works as a starting material for producing dehydrated bovine pizzle (traditional bully stick), and a view of a segment of fresh beef pizzle.

FIG. 15 is a prior art, a cross-section view of a final end product of dehydrated bovine pizzle (traditional bully stick) product after dehydrating process.

FIG. 16 is a prior art, a view of a final product of a dehydrated bully stick with a typical cross-section outline shape resembling capital letter “B”.

FIG. 17 is a prior art, a view of a group of traditional bully stick products with various cross-section outline shapes.

FIG. 18 is a prior art, a view of another group of traditional bully stick products with various cross-section outline shapes.

FIG. 19 is a view of an Artificial Bully Stick (or say Bully Stick Analogue) pet chew according to the disclosure in stick configuration formed by mono-extrusion, with a cross-section outline shape similar to capital letter “B”, and with numerous air bubbles spreading into the chew body.

FIG. 20 is a prior art, a view of various layers of a normal bovine skin.

FIG. 21 shows several cross-section views of a group of exemplary “sheet” extrudates according to embodiments of the present disclosure, produced by various extruder die designs.

### DETAILED DESCRIPTION OF THE EMBODIMENTS

Embodiments are provided in the following description only as examples. The general principles defined in the following description would be applied to other embodiments, alternatives, modifications, equivalents, and applications without departing from the spirit and scope of the present disclosure.

It should be noted that the term of “bully stick” (a kind of dehydrated animal pizzle pet chew) refers to a pet chew product of dehydrated (“dehydrated” herein also equal to “dried”) animal (especially but not limited to bovine animal; bovine herein especially referring to bull or steer) pizzle, or segment thereof, for dogs to chew on, where the pizzle is derived from a natural animal penis cut from slaughtered animals (especially bovine), typically with foreskin being removed. The term of “pizzle” refers to the penis of an animal or a part (such as the outer layer muscle part, the part of tissues of corpus cavernosum and the part of spongiosum) of the penis. Bully sticks (dehydrated animal pizzle chews) come in various shapes and sizes, providing options for different breeds and chewing preferences. Final products of the “dehydrated animal pizzle” may typically be in a stick form but they can alternatively be in any other forms, shapes or structures, such as in a stick form, spiral form, spring form, curl form, ring form, braided form, twisted form, knotted bone form, pretzel form or kabob form. The “Bully Stick” may be alternatively a pet chew product selected from the group consisting of: a dehydrated beef pizzle, a dehydrated bovine pizzle, a dehydrated bully pizzle, a dehydrated cattle pizzle, a dehydrated swine pizzle, a dehydrated deer pizzle, a dehydrated ovine pizzle, a dehydrated caprine pizzle, a dehydrated sheep pizzle, a dehydrated goat pizzle and a beef bully stick. Bovine (especially bull or steer) penis is known in pet chew trade as pizzle. The bully stick is so called traditional bully stick made of a dehydrated natural part of an animal (especially bovine).

Dehydrated bovine pizzle (traditional bully stick) products have some drawbacks, such as:
1. Extremely high cost per gram. Due to the natural scarcity property with the source of natural bovine pizzle, raw materials (bovine pizzle) for producing dehydrated bovine pizzle (traditional bully stick) are sold at an extremely high price, which creates the final products, dehydrated bovine pizzle (traditional bully stick), being sold to consumers at an extremely high price.
2. Materially hard to acquisition due to natural scarcity property with the source of natural bovine pizzle.
3. Strong unpleasant stink/smell which keeps a lot of consumers away from buying it.
4. Too great strength or rigidity. Dehydrated bovine pizzle (traditional bully stick) products have inherently and extremely great strength which may not be in favor of puppies or old dogs with weak jaws or teeth.

On the market, there are other kinds of popular products made of sheet components (the sheet components initially in a sheet form is further manipulated or shaped into final end product configuration) or cylindrical components (the cylindrical components initially in a cylindrical form is further manipulated or shaped into final end product configuration such as spiral, curl, ring or knotted bone) formed by injection-molding or extrusion process and typically formulated by plant-based materials, enjoying materially low-cost. Also, it is a product with “durability” property which can provide a long chewing time for dogs. There is another kind of popular products in a form such as roll, stick, braid and knotted bone, formulated by rawhide or rawhide-based materials, with “durability” property which can provide a long chewing time for dogs. However, these kinds of product are commercialized by many distributors or retailers under great competitions. The competition is a homogeneous one, in which a product is hard to be well distinguished from another. A homogeneity product is considered hard to attract consumers to buy. Additionally, employing rawhide material to make a pet chew may be involved in some negative concerns: A, rawhide does not have attractive flavor urging dogs to chew. B, manufacture of rawhide is a relatively unregulated industry. It may create pollution to environment. H2O2 and NaOH chemicals that are used for rawhide manufacture and heavy metals may remain in finished products which harm dogs' health.

Pet chew of the present disclosure is intended to work as an alternative to traditional (genuine) dehydrated animal pizzle (such as traditional bully sticks) aforementioned.

The term of “Artificial Dehydrated Pizzle pet chew” (or Artificial bully stick pet chew, or say Pizzle-like pet chew) in the present disclosure refers a pet chew or a pet chew member (typically initially in a shape of stick/cylinder) formed from a composition material, imitating or approximating the features of traditional genuine dehydrated (or dried) pizzle (bully stick) product (The bully stick product includes but not limited to a dehydrated beef pizzle, a dehydrated bovine pizzle, a dehydrated bully pizzle, a dehydrated cattle pizzle, a dehydrated swine pizzle, a dehydrated deer pizzle, a dehydrated ovine pizzle, a dehydrated caprine pizzle, a dehydrated sheep pizzle, a dehydrated goat pizzle and a beef bully stick) including the structure, and/or appearance, and/or shape, and/or size, and/or color, and/or texture, and/or flavor, and/or durability, and/or palatability, but it is not a traditional (genuine) bully stick. In some embodiments, Artificial dehydrated animal pizzle chews (artificial bully stick chews) come in various shapes and sizes as final end products, providing options for different breeds and chewing preferences. The final end products of the “Artificial Dehydrated Pizzle pet chew” of the present disclosure can be in any form, shape or structure, such as in a stick form, spiral form, curl form, spring form, ring form, braided form, twisted form, knotted bone form, pretzel form or kabob form. In some exemplary embodiments, an artificial dehydrated pizzle (artificial bully stick) component is formed by extrusion process into a continuous cylindrical extrudate and the extrudate is reshaped or manipulated by hand into a desired final end product shape or form and dried into final product.

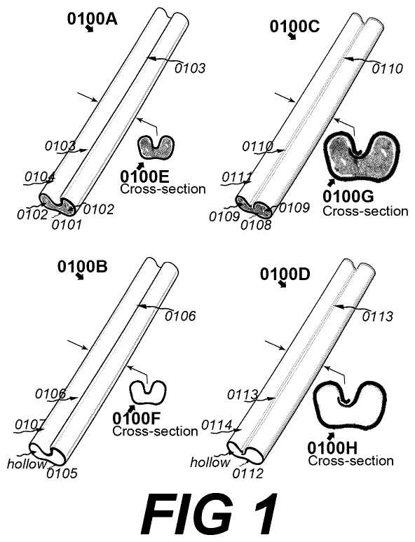

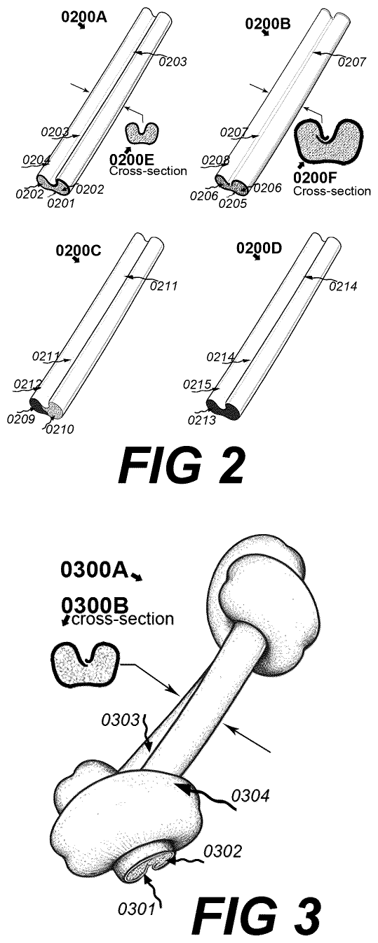

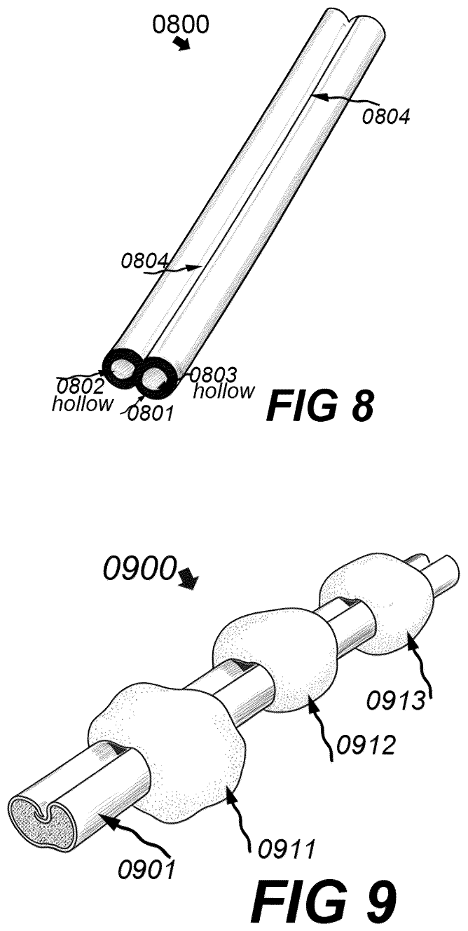

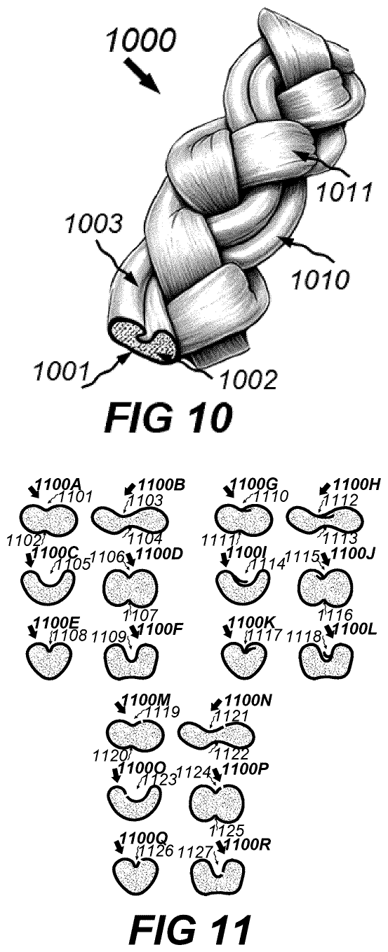

It is known that a market-popular pet chew product may include two major factors, i.e. property of “chewy” (long durability) and property of “inherently good palatability”. “Chewy” means a material that can endure a dog's chewing for a long time before being ingested. “Good palatability” means a material with inherent attractant to dogs without adding additional artificial flavorings. A market-successful pet chew product may be required to have the both excellent properties. The Artificial Dehydrated Pizzle (or artificial bully stick) pet chew as illustrated in the disclosure may be a product with both “inherently good palatability” and “durability”. The term of “single piece” or “one-piece” refers to a material or component consisting of or made in a single undivided piece that may have or may not have segments therein. The “single piece of material” may be the one that is formed from plural pieces or layers that have been joined or welded together. The “single piece of material” may have multiple layers, where the layers are integrally formed and attaching to each other firmly (where the multiple layers together form one) by a process (for example, extrusion process) and usually together form a single piece or one piece (the two parts are not separate). For example, the pet chews have a component as illustrated at 0100B/0100D in FIG. 1, 0200A-0200D in FIG. 2, 0300A in FIG. 3, 0800 from FIG. 8, 0901 from FIGS. 9 and 1000 from FIG. 10 referring to a component formed from a single piece of material. Among them, the artificial bully stick members from the pet chews as illustrated at 0200A-0200D in FIG. 2, 0300A in FIGS. 3 and 1000 from FIG. 10 are in a configuration with outer layer and inner member, which are also considered as being formed from a “single piece of material”. As a comparison, the artificial bully stick members from the pet chews as illustrated in 0100A and 0100C from FIG. 1 have two separated layers not being integrally formed, which are regarded as being formed from a “single piece of material”.

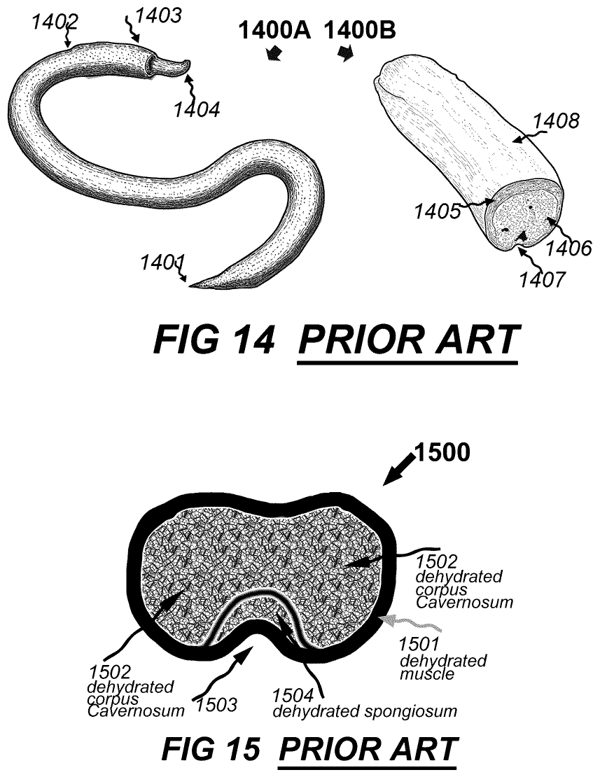

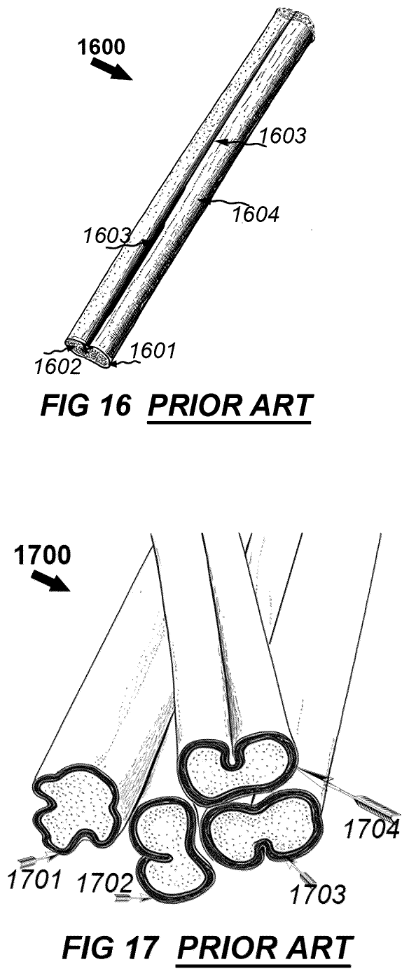

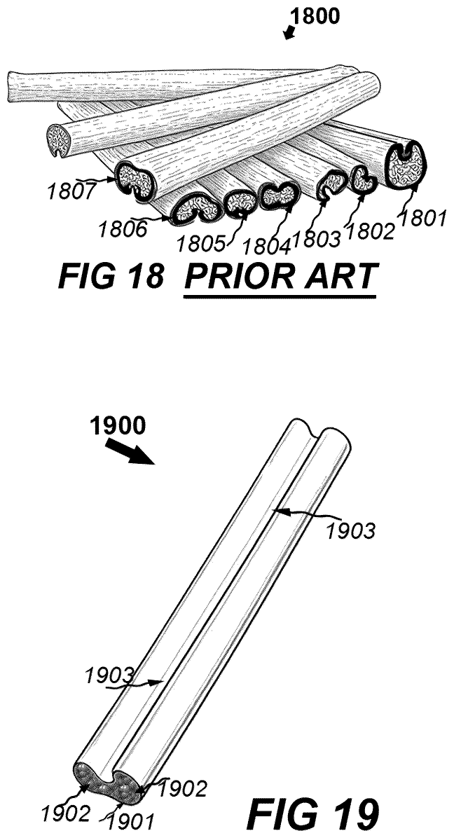

Before developing the embodiments of the present disclosure, as a prior art, here addresses a typical specification/structure/configuration and manufacturing process for these traditional genuine dehydrated bovine pizzle products (bully stick products) as follows (from points 1 to 6):
1. Prepare natural flesh of pizzle. Now refer to FIG. 14 (Prior Art), 1400A gets ready which is cut from a slaughtered bovine animal. 1400A refers to a kind of full length pizzle including both shaft and glans penis part, where the glans part serves as a tapered tail of the whole pizzle, alternatively being tapered to a pointed tip or a rounded tip. 1401 refers to the root of the bovine penis. The shaft part from point 1401 to 1402 is a typical portion of a pizzle that universally is applied to make dehydrated bovine pizzle (bully sticks). 1403 is glans of the pizzle, which also can be included in finished products in some specific products (these specific products may be called full length bully sticks). 1404 refers to the pointed tip of the glans penis, the tapered tail part of the full length pizzle.
2. 1400B from FIG. 14 (Prior Art) is a segment of a fresh pizzle. 1407 refers to a groove longitudinally along the whole pizzle. 1405 is muscle of the pizzle, serving as an outer layer for the whole pizzle piece distinguished from the inner member 1406. 1408 is the surface of the pizzle. Inner member 1406 includes tissues of corpus cavernosum, spongiosum, urethra, etc.
3. Have the pizzle dehydrated by means of for example solar drying, heating or freeze drying. FIG. 15 (Prior Art) is a cross-section figure for a final bully stick product after dehydrating process. This cross-section is in a typical outline shape similar to capital letter “B”. 1501 is dehydrated muscle in hard quality. 1502 is dehydrated corpus cavernosum. 1503 refers to a groove longitudinally along the pizzle. 1504 is dehydrated spongiosum.
4. FIG. 16 (Prior Art) is a final product, a dehydrated bully stick with a typical cross-section outline shape similar to capital letter “B”. 1601 and 1604 is a hard outer layer of the bully stick made of dehydrated muscle. 1602 is an inner member including tissues of corpus cavernosum, spongiosum, urethra, etc. 1603 refers to a groove longitudinally along the whole bully sticks body on its surface.
5. 1701, 1702, 1703 and 1704 in FIG. 17 (Prior Art) reflect a group of various cross-section outline shapes 1700 that a dehydrated bovine pizzle (traditional bully stick) may have. Also 1801 to 1807 in FIG. 18 (Prior Art) reflect another group of various cross-section outline shapes 1800 that a dehydrated bovine pizzle (traditional bully stick) may have
6. The typical outstanding features (including structure features) of a Natural dehydrated animal pizzle product (natural bully stick product) may be derived from and determined by the aforementioned natural features of a natural bovine penis. It is disclosed by the present inventor that, a typical dehydrated bovine pizzle (traditional bully stick) product has its essential typical features as follows (from A to K):
A. An inherent groove appears longitudinally along the whole Bully Sticks body. The Products in FIGS. 15 (prior art) and 16 (prior art) reflect this feature. This structural feature (groove) is a common one to most typical bully sticks products. (Arriving at identifying this common feature requires careful observations. There are various shapes/structures/appearance that bull stick products possess, which makes it hard to identify a common structural feature. The present applicant surprisingly discloses that, “groove” is a key feature that most typical bully sticks products possess although they have various shapes/structures and various cross-section shapes. This disclosure discloses a perfect imitation method to imitate or approximate traditional bully stick appearance.).
B. Cross-section of traditional bully stick presents characteristic outline shapes. A typical outline is in a shape similar to capital letter “B”, peanut (peanut icon), cashew nut (cashew nut icon), Arabic numeral “8”, or heart icon. These typical outline shapes have a common feature that they have a “trough” area that is significantly lower than the surface. The “troughs” appearing on the outline shapes are created by aforementioned “groove” that runs longitudinally along the bully stick body. The items illustrated in FIGS. 15 (Prior Art) and 16 (Prior Art) reflect this feature. Some other outline shapes are described in FIGS. 17 (Prior Art) and 18 (Prior Art). These outline shapes are created by inherent feature of natural pizzle.
C. It is inherently a stick shape product. And in some other bully stick products, it is initially in a stick shape and is finally manipulated to a desired shape such as Knot, Spiral or Braid different from the initial stick shape.
D. Bully stick has animal pizzle ingredient, which is a very strong flavor product enjoying an irresistible attraction to dogs. Animal pizzle ingredient offers “inherently good palatability” for the pet chew.
E. Dehydrated pizzle products (bully sticks) may include an outer layer and an inner member, where the former holds the latter by surrounding it. This structure is derived from pizzle inherent structure. The outer layer is formed by muscle and inner member formed by tissues of corpus cavernosum, spongiosum, urethra, etc. Products in FIGS. 15 (Prior Art) and 16 (Prior Art) reflect this pet chew structure.
F. After being dehydrated, inherently, the outer layer of dehydrated pizzle (bully stick) formed by muscle enjoys a property of getting hard. The hardness ideally accommodates dog's chewing desire, making it an ideal pet chew product. Traditional dehydrated pizzle (bully stick) makes itself outstanding in the aspect of extraordinary durability or hardness.
G. Typical properties of the outer layer include: being translucent (semi-transparent) in the whole outer layer or in a portion of the outer layer, and with fiber-like texture. (These two properties of outer layer are created by the nature of the muscle that forms the outer layer.)
H. Typical range of thickness of the outer layer is 0.3 mm-5 mm.
I. Typical properties of the inner member/portion include: spongy, comparatively more unconsolidated or looser in texture than the muscle outer layer/portion. For example, FIGS. 15 (prior art) and 16 (prior art), product 1500/1600 has an inner member 1502/1602 which includes tissues of corpus cavernosum, spongiosum and urethra, which is unconsolidated. And there are some small bubbles/blisters/pores spread substantially homogeneously to the inner member material. Refer to FIG. 15 (prior art), 1502 from bully stick has a plurality of tiny bubbles/blisters/pores. These properties of inner member are created by the nature of corpus cavernosum and/or spongiosum tissues that exist in a pizzle.
J. Inner member/portion and outer layer/portion have different appearance in color and/or texture. Inner member/portion color is comparatively lighter than outer layer/portion color. Inner member/portion color is typically white or yellowing white. Outer layer/portion color is typically light brown, brown, dark brown, red brown or muscle color. For example, 1602 from pet chew 1600 is in white color and 1601 is in light brown. Density of inner member is lighter than Bully Stick outer layer. For example, 1602 is lighter than 1601 in density. These properties of color recognition are created by the nature of a pizzle.
K. Pizzle flavor. Traditional dehydrated pizzle product (bully stick) has an inherent characteristic pizzle flavor, which greatly attracts dogs to chew. As a sort of meat-by-products material, pizzle has a naturally strong flavor as other meat-by-products do, attractant to dogs.

The term of “component” in the present disclosure may be defined as a constituent part or aspect of something more complex (e.g., a component of a pet chew). Typically, the term of “component” (e.g. the extruded collagen-based artificial bully stick component) in the present disclosure may refer to a separate component (or member) in final end product of a pet chew being separate or distinct from other component(s), member(s) or part(s) (such as a separate beef-hide sheet member), in which the separate component (or member) may be usually manually separable from other component(s), member(s) or part(s) by hand.

Collagen is an essential protein for dogs, found in various parts of their body, and its loss with age may lead to health issues such as arthritis, coat and skin problems, and digestive issues. A common recommendation is to give approximately 1 to 2 grams of collagen per 10 pounds of body weight. Many dog owners find it is a challenge to give collagen supplements to their dogs by feeding a capsule or a pill-like treat containing the supplements whereas a diet with collagen goes easier. Adding collagen to a dog's diet can provide many benefits such as pain and arthritis relief, a healthy coat, improved skin health, joint and bone health, improved digestion, or digestibility, reduced joint pain, reduced inflammation, support for post-operation recovery and increased appetite. On the market, a bunch of natural collagen sheet chews that are made of an innermost layer of beef skin in their naturally-occurring sheet form (without undertaking grounding process or another to destroy its natural form) or other non-rawhide animal skin materials have been introduced to offer the collagen benefits to dogs. These natural collagen sheet chew products suffer with some drawbacks as follows. Manufacturing a quality natural collagen sheet chew (such as a mini-sized knot bone) involves preparation of natural collagen sheet material which need comply with particular pre-determined raw material quality standards such as standards for the size, thickness and unevenness of collagen sheet raw material, which may result in a comparatively expensive raw material. And the manufacturing practices, especially the trimming process to prepare rectangular-shaped collagen sheet raw materials, may create lots of collagen sheet piece leftovers. Though natural collagen sheet may perform better than rawhide in health aspect, natural collagen sheet still to some extent suffers with digestibility and attraction issue, and is considered unsafe for dogs in a jeopardy of getting choked or hurt by sharp edges while gnawing on. On the market, a kind of plant-based sheet chews can also be found to replace traditional rawhide chews.

The term of “fin” in the present disclosure, for example the “fin” from the phrase of “tubular component with fin”, “tubular extrudate with fin”, “finned tubular component” or “finned tubular extrudate”, generally refers to a projecting thin piece sticking out (or extending) from the main body of the tubular object/component/extrudate and extending or running (longitudinally) along the length of the main body; there is a space or distance between the extreme edge (the edge far from the surface of the tubular object) of the projecting thin piece and the main tube body, or in other words, the extreme edge of the projecting thin piece is free from the tube body object. Preferably, the “fin” part and the main tube body part are integrally formed (the fin and the main tube body together form one) by extrusion process and may usually together form a single piece or one piece (the two parts are not separate). Typically, in a finned tubular component/extrudate (or tubular component/extrudate with a fin), one extremity of the width of a fin is attached to a surface of the tube body and the opposite extremity is a free end (spaced from the surface of the main tuber body). A “fin” is typically in a thin and curved form (“curved” herein refers to an object whose cross-section is a curve), while it could be in a thin and flat form instead in some other embodiments. Typically, a “fin” of this term is a sheet-like part (resembling a sheet in shape or appearance) sticking out from the main tube body of the tubular object/component/extrudate. Typically, a “fin” sticks out at a slant from the main tube body. In geometry, in a finned tubular extrudate, a plane of a “fin” and a plane of the surface where the fin is attached to the main tube body form an angle, in which typically the angle is an acute one (more typically an angle is substantially less than 60 degrees which may approximate that of a free end on the surface of a rolled cylinder formed from sheet). A “fin” of the disclosure may be present on the exterior and/or interior surface of the main body part of a finned tubular component. Typically, a “fin” is present on the exterior (external) surface of the main body part of a finned tubular component (the fin may be referred to as exterior fin herein); in some embodiments, a “fin” is present on the interior (internal) surface of the main body part (the fin may be referred to as interior fin). Typically, an overall length of a fin is substantially equal to an overall length of the tube body part.

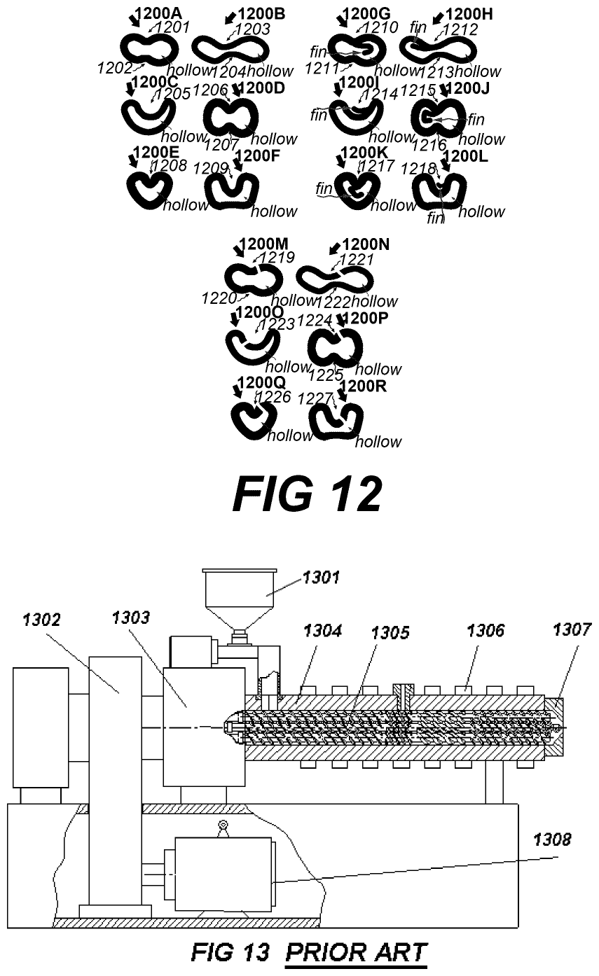

In some preferred embodiments, a “fin” inherently exists on an extruded tubular component/extrudate (an artificial bully stick component/extrudate) generated by an extruder, where the “fin” is dictated and inherently created by the extruder die design. The width of a fin is defined as a measurement that measures the distance along the material (in a direction substantially perpendicular to the longitudinal center line of the main tube body) from the surface of the main tube body (where the fin is attached to the tube body) to the far end (or extreme end, or furthest end or edge) of the fin of a finned tubular component. For the aforementioned exterior fin, in some preferred embodiments, the average thickness and the average width (the width measured in a way starting at the tube body surface till the far edge of the fin) are in a ratio less than 1:1 (more preferably a ratio less than 1:3), where the ratio ranges may provide visually “thin” property to the fin (for example, when a width is set at a fixed value, e.g. 8 mm, the less the ratio is, the thinner the fin looks). A “tubular object/component/extrudate with fin” may also be called “finned tubular object/component/extrudate” or “tube-shaped object/component/extrudate with fin” in the disclosure. When a rectangular sheet is rolled into a rolled cylindrical profile (along its width, for example) by rolling about one time along its width or by wrapping around itself multiple times, naturally there may be a free end (remaining end part) of the sheet extending (or protruding) from the rolled cylinder edge (or protruding from the main rolled cylinder body part in a circumferential direction). The fin (esp. on exterior surface of tube body part) on the tubular object/component as taught in the present disclosure may look like (or approximate) a free end part of a rolled rectangular sheet, in which the sheet is rolled into a hollow rolled cylinder with a free end (remaining end part) of the sheet extending (or sticking out, or protruding) from the rolled cylinder edge (or protruding from the main cylinder body part in a circumferential direction), thus making the “finned tubular object/component” much close to an illusion that the finned object/component is formed form a sheet material rather than a tube. In this fashion, the main tube body part of the “tubular object/component with fin” corresponds to the rolled cylinder main body formed by the sheet and the fin part corresponds to the free end (remaining end part) of the sheet extending (or protruding) from the rolled cylinder edge (or protruding from the main cylinder body part in a circumferential direction). As illustrated in FIG. 12, Finned Tubular Artificial-Dehydrated-Pizzle Extrudate 1200G-1200L (cross-sectional views) is formed of an extrudate formed by mono-extrusion process, where the fin part is annotated with the word of “fin” thereat, a projecting thin piece sticking out from the main tube body of Finned Tubular Artificial-Dehydrated-Pizzle Extrudate 1200G-1200L and extending along the length of the main extrudate body. A regular Rolled Sheet Cylinder is initially in a flat rectangular sheet form and then rolled into a rolled cylindrical profile along its width by rolling about one time with a free end (remaining end part) of the sheet extending from the rolled cylinder edge (or protruding from the main rolled cylinder body part in a circumferential direction). Comparing Finned Tubular Artificial-Dehydrated-Pizzle Extrudate 1200G-1200L and a regular Rolled Sheet Cylinder, Finned Tubular Artificial-Dehydrated-Pizzle Extrudate 1200G-1200L in appearance as a whole greatly resembles a Rolled Sheet Cylinder (to form an artificial bully stick component) in shape and structure and contributing to the presence of the fin part, the fin on the Finned Tubular Artificial-Dehydrated-Pizzle Extrudate 1200G-1200L makes it much close to an illusion that Finned Tubular Artificial-Dehydrated-Pizzle Extrudate 1200G-1200L is formed form a sheet material, where the Fin Part projecting thin piece sticking out from the main body of Finned Tubular Artificial-Dehydrated-Pizzle Extrudate 1200G-1200L looks nearly identical in structure/configuration/shape to the Free End at an end of the sheet extending from the rolled cylinder edge (or protruding from the main cylinder body part in a circumferential direction). Another benefit that a finned tubular component may provide may be that: it can generate comparatively greater width extrudate (this width is counted in a method that the finned tubular component is converted into a corresponding sheet by fully spreading into a sheet) when the corresponding sheet for comparison is extruded with a same diameter extruder die, which the capability is increased for a same extruder equipment. For example, the maximum extruder die diameter that a specific extruder equipment can take is 12 cm, which can produce at most 10 cm wide sheet extrudate. While applying the same extruder equipment to produce a finned tubular component, it may produce an extrudate with 35 cm width (the width is counted as the finned tubular component is converted into a corresponding sheet by fully spreading into a sheet). Yet another benefit that a finned tubular component may provide is that: a fin(s) appearing on the surface of main tube body can obtain a favorable surface texture thus providing favorable mechanical tooth cleaning effect. Typically, the average width of a “fin” on a finned tubular object (component) in the present disclosure is at least 2 mm. 2 mm width fin could be the least size that could provide the desired benefits of introduction of a “fin” to a tubular component described in the disclosure. Typically, the average thickness of a “fin” ranges from to 0.2 mm to 10 mm (more typically 0.3 mm to 5 mm). Typically, the average wall thickness of the tube body part of a finned tubular component ranges from to 0.2 mm to 20 mm (more typically 0.3 mm to 5 mm). Typically, the average thickness of a “fin” on a finned tubular object (component) in the present disclosure and the average thickness of the wall of the main body part of the finned tubular object (component) are in a ratio between 1:10 and 10:1 (more typically between 1:5 and 3:1), in which a fin with an average thickness out of the ratio could make it quite away from the imitation of a free end part to a rolled sheet cylinder object. More typically, an average thickness of the tube body part is equal to or greater than an average thickness of the fin. In some embodiments, the average thickness of a “fin” on a finned tubular object (component) in the present disclosure is either equal to, similar to, less than or no significantly larger than the average thickness of the wall of the main body part of the finned tubular object (component), in which it could serve an excellent imitation purpose of a free end part to a rolled sheet cylinder object formed of a common sheet material with an approximately homogeneous thickness through the material.

The total number of “fin(s)” present on the exterior surface or interior surface of a finned tubular component/object/extrudate (or also be referred to as tubular object/component/extrudate with fin) is typically one. There is naturally only a single free end (remaining end part) of a sheet extending (or protruding) from the edge of a rolled cylinder (or protruding away from exterior surface or interior surface of the main cylinder body part along the circumference in a circumferential direction) formed by rolling the sheet. But in some embodiments, the number of “fin(s)” could be larger than one, for example two or three as desired, spread to the exterior or interior surface. It is noted that the number of the exterior “fin(s)” on a “tubular object (component) with fin” article is preferred to be no greater than three since a tubular object/component with four or more fins on its exterior surface may in appearance be significantly away from the illusion purpose that the object/component were formed form a sheet material since there is naturally only a single free end (remaining end part) of the sheet extending (or protruding) from the rolled cylinder edge (or protruding away from exterior surface of the main cylinder body part in a circumferential direction). A tubular object/component with four or more fins on its exterior surface seems far away from a single free end (remaining end part) of the sheet sticking out from the rolled cylinder edge (or protruding from the main cylinder body part in a circumferential direction). As for the embodiments that the fin(s) present on the interior surface of a finned tubular component/object/extrudate, while the number of “fin(s)” may be typically one, the number of “fin(s)” may vary as desired.

The term of “collagen” in the present disclosure under a broader sense may refer to any form of collagen, in which the collagen may be present in the forms including but not limited to: a collagen molecule, a collagen chemical, a collagen compound, a collagen supplement (natural or synthetic), a compound consisting essentially of collagen molecule, a collagen composite consisting essentially of collagen molecule, collagen molecule/chemical/compound contained in a naturally-occurring material as a source of collagen, a collagen peptide (“collagen peptide” herein is derived from collagen through a process such as enzymatic hydrolysis process, which breaks down the large collagen molecules into smaller peptides and this enzymatic process results in collagen peptides with a low molecular weight, making them highly bioavailable and easily absorbed; “collagen peptide” may also be referred to as “hydrolyzed collagen” in some cases), a hydrolyzed collagen, extracted collagen molecule from animal natural parts and any combination thereof. Typically, the term of “collagen” in the present disclosure refers to any one of: a collagen molecule, a collagen chemical, a collagen supplement (natural or synthetic), a collagen peptide, a hydrolyzed collagen and any combination thereof. Some “collagens” in the present disclosure may be prepared by hydrolysis or extraction from natural Animal Parts such as cartilage, skin, and tendon. Regarding collagen extraction, collagen can be basically obtained by chemical hydrolysis and enzymatic hydrolysis. In some embodiments, “collagen” particularly refers to corium (dermis) part of animal skin treated by enzymatic method. In some embodiments, “collagen” may refer to various collagen types and the term of “collagen” in the present disclosure may be of any types such as UC-II, type I, III, IV, V, X. Collagen type I has a rod-like structure made of three helically coiled chains. Fibrillar collagen such as the corium (or dermis) layer of animal skin (such as bovine skin, porcine skin, beef hide, porkhide) may be of type I collagen as the most abundant fibrillar collagen in most tissues is type I collagen. Fibrillar collagen is primarily present in fibril surfaces and connective tissues of the skin and bones. “Collagen” is a protein that is crucial for dog's overall well-being. It makes up a significant part of the skin, bones, tendons, and other connective tissues. Undenatured type II collagen (also known as UC-II collagen) for dogs, in particular, may play a vital role in joint health. Among the various types of “collagens” aforementioned, UC-II Collagen may play a critical role in dog's overall health, from boosting joint mobility to enhancing their skin and coat. UC-II collagen is a form of undenatured type II collagen that may be prepared by extraction from animal cartilage (e.g., chicken sternum cartilage). Unlike hydrolyzed collagen, UC-II collagen retains its original triple-helix structure. This unique structure plays a key role in its effectiveness for joint health. In some embodiments, the collagen constituent in a pet chew of the present disclosure is UC-II collagen. Much like collagen, gelatin is a mix of amino acid chains. Gelatin is made by heating or treating collagen, and is therefore a mixture of the amino acids found in collagen. To prepare gelatin, some of the chemical bonds of collagen have been broken due to processing. In the present disclosure, gelatin may be employed to form the formula of a collagen-based composition to form an artificial dehydrated pizzle component, as a kind of “collagen”, though it is not preferred considering its nutritional value vs. normal collagen.

As a contrast, “collagen” in a scientific definition in a narrower sense may refer to the fundamental elements of various connective tissues in animal bodies (such as skin, tendons, and ligaments), as one of the most abundant proteins in animal bodies produce, which may be made from three chains of amino acids arranged into a helix pattern that may be found in animal muscles, tendons, cartilage, skin and bones. Amino acid glycine may be present in most collagen chains, with proline and hydroxyproline also being common.

The term of “animal skin (esp. bovine skin, porcine skin)” may refer to a skin material composed of several layers, where the layers may include epidermis layer (epidermis may also be referred to as tough outer layer), dermis layer (dermis may also be referred to as corium). A hypodermis (flesh layer may be a part of the hypodermis) layer may also be mentioned, but in the industry, the hypodermis layer may not be considered a part of “animal skin”.

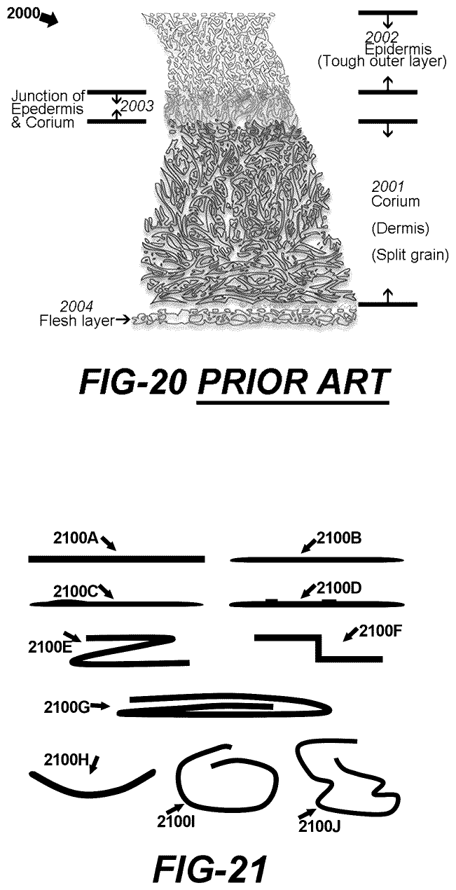

The term of “collagen-based” in the present disclosure may refer to a composition material containing any one of: at least 20% collagen-rich (naturally-collagen-rich) material by weight, at least 10% collagen (constituent, element, or ingredient) by weight and a combination thereof. Typically, the “collagen-based” composition contains at least 25% (more typically, at least 30%) naturally-collagen-rich material by weight or at least 10% collagen (constituent, element, or ingredient) by weight, where “at least 25% collagen-rich (naturally-collagen-rich)” in the composition may be in accordance with the “dinners, entrees, platters, nuggets, recipe and formulas” rule under existing AAFCO labeling requirement. In some embodiments, all naturally-collagen-rich material ingredient(s) existing in the “collagen-based” composition added together account for the number one proportion ingredient(s) in the material by weight, which is larger than any other individual (or single) ingredient existing in the material (such as corn starch, isolated soybean protein, chicken, chicken liver, glycerin, sugar, sorbitol, and vegetables). In some embodiments of the present disclosure, the “collagen-based” composition contains at least 50% collagen-rich (naturally-collagen-rich) material by weight, in which naturally-collagen-rich material may serve as a majority ingredient by weight in the constitution of the composition. To form the finned tubular component (or the extruded sheet, or the extruded tubular component), in some preferred embodiments, the “collagen-based” composition contains no greater than 90% collagen-rich (naturally-collagen-rich) material (or no greater than 80% collagen constituent) by weight, which may well accommodate the extrusion process requirements for extruding the composition and may produce a durable extrudate in final end product. In some embodiments of the present disclosure, typically the “collagen-based” composition contains at least 25% (more typically at least 30%) collagen (constituent, element, or ingredient) by weight in final end product, where “at least 25% collagen (constituent, element or ingredient)” in the composition may meet the “dinners, entrees, platters, nuggets, recipe and formulas” rule under existing AAFCO labeling requirement. In some embodiments of the present disclosure, the “collagen-based” composition contains at least 50% collagen (constituent, element, or ingredient) by weight, in which collagen (constituent, element or ingredient) may serve as a majority constituent by weight in the constitution of the composition. In some embodiments of the present disclosure, to form the “collagen-based” composition, the naturally-collagen-rich material is any one of: corium (layer) part of animal skin (animal skin such as beef skin, pork skin, bovine skin, porcine skin), dermis (layer) part of animal skin (animal skin such as beef skin, pork skin, bovine skin, porcine skin), innermost layer of animal skin (animal skin such as beef skin, pork skin, bovine skin, porcine skin), inner layer of animal skin (animal skin such as beef skin, pork skin, bovine skin, porcine skin), cartilage, trachea, animal ear, poultry foot, esophagus, animal pizzle, ligament, pericardium, animal tendon, eggshell membrane and any combination thereof. The phrase of “-based” generally means: (in a composition material) containing something as an important feature (or important part) (e.g., lead-based paints, collagen-based composition). The term of “naturally-collagen-rich” (equal to “inherently-collagen-rich) material, mainly as a particular meat by-product, in the present disclosure generally refers to any one of: a naturally occurring animal material (or a natural Animal Part material, or a natural organ material) that inherently/naturally contains at least 50% collagen (where collagen constituent may exist as a majority constituent by weight in the material) on a dry matter basis; an animal material that is derived from a naturally occurring animal material (or a natural Animal Parts material, or a natural organ material) that inherently/naturally contains at least 50% collagen (on a dry matter basis) without aid of added collagen (where collagen constituent may exist as a majority constituent by weight in the material); and any combination thereof. Some typical examples of these “naturally-collagen-rich” material includes: corium (layer) part of animal skin, dermis (layer) part of animal skin, innermost layer of animal skin, inner layer of animal skin, cartilage, trachea, animal ear, poultry foot, esophagus, animal pizzle, ligament, pericardium, animal tendon, eggshell membrane, and any combination thereof. Corium (layer) or dermis (layer) part of animal skin (refer to dermis 2001 of a bovine skin in FIG. 20 as an example), commonly obtained from bovine skin, porcine skin, ovine skin or caprine skin and especially obtained from bovine skin or porcine skin, may be a preferred embodiment of the “naturally-collagen-rich” material employed in the present disclosure as it usually contains at least 70% collagen (on a dry matter basis) (an example of corium layer of cattle skin sourced from a supplier contains about 89% collagen on a dry matter basis) and is of easy acquisition from the market. Preferably, the corium layer of animal skin does not undertake the process that rawhide regularly is prepared by as described in the definition paragraph of “rawhide” in the disclosure. Corium layer may be referred to as split (grain) layer as well. The particular layer of skin for rawhide manufacture such as the epidermis layer (refer to epidermis 2002 of a bovine skin in FIG. 20 as an example) may be particularly avoided due to the reasons mentioned somewhere in the present disclosure. The layer of “junction of epidermis and corium” (refer to layer 2003 of a bovine skin in FIG. 20) may also be used as a “naturally collagen-rich” material to make a pet chew in conjunction of corium layer as a part of the corium layer while sometimes the layer of “junction of epidermis and corium” could be an inferior material choice. In some embodiments, the “collagen-based” material may refer to an “animal skin corium layer-based” material formed from a composition including 25%-90% (or typically 50%-90%) corium layer of animal skin ingredient by weight in formula, in which animal skin corium layer ingredient preferably accounts for the number one proportion ingredient by weight, which is larger than any other individual (or single) ingredient existing in the material (e.g. corn starch, isolated soybean protein, glycerin, chicken liver, sugar, sorbitol). Examples of “naturally-collagen-rich” material may also include non-rawhide animal skins such as poultry skin, turkey skin, ostrich skin, fish skin (they are not available for leather manufacture industry) while sometimes they could be of an inferior choice. Collagen content (on a dry matter basis) data of some specific meat by-products may be referred to as follows (actual collagen content may vary from these according to actual tested samples): corium layer of skin-89%, tendon-85%, intestine-19%, lung-18%, stomach-13%, animal bone-24%, kidney-5.2% and liver-2%. As for “meat” (muscle), it may contain less than 10% collagen. Other meat by-product materials (meat as well) that inherently contain less than 50% collagen (on a dry matter basis) may not be included in the scope of the definition of “naturally-collagen-rich” material because: applying the material in the aim of increasing the collagen content in a pet chew may ask for comparatively much more proportion of this material in the chew extrudate and the large proportion may not comply with other materials to produce an extrudate or not be adapted to the following extrusion process or even ruin the following extrusion process to produce a chewing-durable component to make an end product of a chew. (Notes: According to AAFCO, the “25%” or “dinner” rule applies to many canned and dry products. If the named ingredients comprise at least 25% of the product (not counting the water for processing), but less than 95%, the name must include a qualifying descriptive term, such as “Dinner” as in “Beef Dinner for Dogs”). Typically, a collagen-based composition material in the present disclosure has a chemical (e.g. humectant chemical such as glycerin, sorbitol) in the formula. In some embodiments, a collagen-based composition material in the present disclosure may have 2%-35% humectant (more typically 10%-25% humectants; humectants such as glycerin, sorbitol) ingredients as a kind of chemical in addition to naturally-collagen-rich material (or collagen constituent) ingredient.

A “cartilage-based” material may refer to a material including at least 10% (more typically at least 20%) cartilage constituent (or element, or ingredient) by weight in the composition.

“Gelatin” is made by heating or treating collagen and forms a gel when cooled. Gelatin may be formed by the partial hydrolysis of collagen, where hydrolysis breaks down the secondary and higher bonding interactions between the crosslinked polypeptide chains, resulting in the loss of the collagen's fibrous structure and the production of gelatin. As a contrast, “collagen peptide” herein is derived from collagen through a process such as enzymatic hydrolysis process, which breaks down the large collagen molecules into smaller peptides and this enzymatic process results in collagen peptides with a low molecular weight, making them highly bioavailable and easily absorbed. “Collagen peptide” may also be referred to as “hydrolyzed collagen” in some cases. “Collagen peptides” are soluble in water including cold and hot water, but “gelatin” is only soluble in hot water and will gel when cooled. If the intended health goal of feeding is to up dog's amino acids to help boost its natural collagen production, then in most cases, highly digestible collagen peptide in a chew recipe will be most beneficial. Both collagen and gelatin are proteins that contain amino acids. Collagen peptide or hydrolyzed collagen has been broken down into even smaller pieces than gelatin, making this type of collagen more bioavailable. In this bioavailability perspective, collagen peptides are a better option than gelatin as used in a chew recipe.

“Glucosamine” in the present disclosure may refer to a Glucosamine chemical, or a Glucosamine molecule, or a Glucosamine compound, or a Glucosamine supplement, or a compound containing Glucosamine, or a Glucosamine constituent. “Chondroitin” in the present disclosure may refer to a Chondroitin chemical, or a Chondroitin molecule, or a Chondroitin compound, or a Chondroitin supplement, or a compound containing Chondroitin, or a Chondroitin constituent. Glucosamine/Chondroitin may be introduced to the pet chews of the present disclosure by means as follows: directly applying a synthetic Glucosamine/Chondroitin supplement substance or Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium, and chondroitin hydrochloride) into the formula as an ingredient.

In some embodiments of the present disclosure, it is to provide a pet chew having an artificial dehydrated pizzle component whose formula includes an ingredient selected from the group consisting of: a naturally glucosamine-rich material, a naturally chondroitin-rich material, a synthetic glucosamine, a synthetic chondroitin, a glucosamine supplement material, a chondroitin supplement material, a glucosamine compound, a chondroitin compound, a glucosamine sulfate, a chondroitin sulfate, a glucosamine hydrochloride, a chondroitin hydrochloride and any combination thereof, in the chew, providing joint health benefits to dogs. In at least one embodiment of these, it is to provide a pet chew including an ingredient selected from the group consisting of (by weight): at least 3% trachea material, at least 3% esophagus material, at least 3% cartilage material, at least 3% naturally cartilage-rich material, at least 3% naturally glucosamine-rich material, at least 3% naturally chondroitin-rich material, at least 0.2% synthetic glucosamine, at least 0.1% synthetic chondroitin, at least 0.2% glucosamine supplement material, at least 0.1% chondroitin supplement material, at least 0.2% glucosamine compound, at least 0.1% chondroitin compound, at least 0.2% glucosamine sulfate, at least 0.1% chondroitin sulfate, at least 0.2% glucosamine hydrochloride, at least 0.1% chondroitin hydrochloride and any combination thereof, in the chew.

The term of “composition” or “composite” in the present disclosure generally may refer to a product of mixing or combining two or more ingredients or elements (or constituents, or materials), esp. a mixture of the ingredients (elements or materials). But it should be noted that, somewhere in the present disclosure, the term of “composition” may also refer to the ingredients (parts) of which something is composed or made of; constitution. For example, an artificial dehydrated pizzle component of a pet chew is made of a meat-based “composition” material, where the formula of the meat-based composition material includes the ingredients of chicken breast and corn starch and chicken liver (three distinct ingredients herein), in which the ingredients may be ground, blended and mixed together before formed into an end product. Again, for example, a collagen-based extruded sheet Artificial-Dehydrated-Pizzle component is made of a collagen-based “composition” material, where the formula of the collagen-based composition material includes the ingredients of potato starch, ground chicken cartilage and glycerin (three distinct ingredients herein). The “composition” material (or composition material) may be formed by any workable or desired recipe, examples of which may be a collagen-based material, plant-based material, or a corium of beef skin-based material. Usually, a “composition” material is an artificial material rather than a naturally occurring material (e.g., a corium layer of beef skin employed as a single ingredient material is a naturally occurring material). Examples of the aforementioned naturally occurring materials may include a corium layer of porcine skin, chicken cartilage, turkey tendon and beef trachea obtained from slaughtered from animals and employed as a single ingredient material. Edible pet chews may be divided into two categories, the Natural Chews (such as the chews derived from a certain Natural (Body) Part (organ) of a slaughtered animal) and the Composite Chews (chews made of composite materials or artificial composite materials). “Natural Chews” generally are made of naturally occurring materials such as beef skin (a source of collagen), beef trachea, pork rawhide sheet, chicken breast, beef hooves, beef bones, antler, etc. “Natural part (organ)” generally refers to a part (an organ) of a slaughtered animal such as beef rawhide, beef skin (a source of collagen), beef bones (a source of collagen), chicken leg, pizzle, beef tendon (a source of collagen), chicken breast, trachea, esophagus, chicken liver, etc., which could be rendered by a simply drying process before being served to a dog. On the other hand, if a natural part (for example, beef tendon) is pre-treated by a grounding process, where its natural inherent form is thus altered, mixed with other materials such as potato starch and sorbitol to make a composite, shaped by a mold to take a stick shape and then finally harden and dried to a stick-shaped or sheet-shaped chew, it thus makes a Composite Chew.

The term of “longitudinal” or “longitudinally” generally in the present disclosure generally means “running/extending from one end of an object to the other rather than across it from side to side; in a direction or position along the length of something”. For examples, when a fin extends longitudinally on the surface of a finned tube component, it runs in a direction from one opening of the tube to the other. In contrast, “latitudinal” or “latitudinally” in the present disclosure generally means “in a direction widthwise, or horizontally, or substantially perpendicular to the centerline (longest axis) of an object”. For example, when something extends “latitudinally” on/in the surface of a tubular object, it runs/extends along a circumference of the tubular object in a direction substantially perpendicular to the centerline (longest axis) of the tubular object.

It should be noted the term of “rawhide sheet” or “rawhide” in the chew industry as a most popular material to form dog chews, generally refers to a layer of skin/hide obtained from slaughter of animals (especially the animals such as bovine, porcine, cattle, cow, water buffalo and pig), which is made of a by-product of the leather industry. The “rawhide” may not be exposed to tanning process or may be partially tanned and generally fur, meat and fat is removed. It may also be called traditional rawhide. As a typical process to prepare the rawhide, split the layer of skin to a number of more layers according to pre-determined thickness, soak the split layers in lime solution and clean (and bleach) the skins in rolling drums, have it sterilized with hydrogen peroxide, and dry the skin layers to a moisture content less than 30% or so. In the whole process, a range of chemicals, such as lime solution, NaOH, NH4Cl, are deployed. The term of “rawhide-free animal skin” or “animal skin free of rawhide” in the present disclosure refers to the animal skin layer materials that are free of aforementioned rawhide and/or the aforementioned manufacturing process and does not fall into the definition of aforementioned rawhide. “Corium (dermis) layer of animal skin” or “innermost layer of animal skin” as employed in the present disclosure is an embodiment of the “rawhide-free animal skin”. Compared to rawhide material that is largely used in chew recipe for decades, since “corium (dermis) layer of animal skin” collagen material is made from much more natural sources, they are considered to be much less involved in adding chemicals in the process of hide manufacture or even free of the chemical additives (such as NH4CL, H2O2 and NaOH) commonly found in rawhide material production. What's more, rawhide may not be easily digestible and end up causing unnecessary digestive discomfort. The corium (dermis) layer of animal skin typically is made from natural sources of collagen, such as beef skin. Unlike rawhide, corium (dermis) layer of animal skin undergoes minimal processing, making them a more natural option. Since corium (dermis) layer of animal skin is made from natural sources, they are free of the chemical additives commonly found in rawhide manufacture. This makes it a more natural treat option.

In a narrow sense, the term of “sheet” generally refers to a thin flat material (after its being spread, unfolded, unrolled or flatted out in certain cases), which is thin in comparison to its length and breadth, typically in a square or rectangular shape, of which both opposite sides (the top side and the bottom side) are substantially smooth and of which the thickness typically is substantially homogeneous throughout the material (a common sheet in narrow sense has a homogeneous thickness, however, a sheet in narrow sense may alternatively have different thickness in different part of it). While referring a material as being “thin”, it means that the distance between the two opposite sides (the top side and the bottom side) of the material in comparison to its length and breadth is small. Typically, the average thickness of a “sheet” ranges from 0.2 mm to 20 mm (more typically 0.3 mm to 5 mm). Alternatively, the “sheet” in narrow sense may be in any desired shapes or forms other than the aforementioned rectangular shape. Alternatively, the “sheet” in narrow sense may initially be in a flat form with a cross-section shape of a flat line and finally be shaped (for example by curving, bending, folding, rolling, knotting or wrapping) to a final form with a cross-section shape of a curve (similar to the curves as presented by cross-section shapes of extrudate 2100E-2100J in FIG. 21), or to a final form of Bi Fold (sheet with a single fold, both of almost equal size), Tri Fold (sheet with 2 folds, with 3 sections flaps folding inward) or Z Fold (sheet is folded into Thirds, with 2 folds and with 3 sections of equal or different size; flaps fold back and forth to make a Z). Alternatively, the “sheet” in narrow sense may initially be in a curved form with a cross-section shape of a curve, or initially be in a form of Bi Fold (sheet with a single fold, both of almost equal size), Tri Fold (sheet with 2 folds, with 3 sections flaps folding inward) or Z Fold (sheet is folded into Thirds, with 2 folds and with 3 sections of equal or different size; flaps fold back and forth to make a Z), or initially be in a form of rolled sheet, where the initial forms are produced by extrusion process through extruder dies with a pre-designed extruder die orifice shape and configuration (refer to the cross-section shapes of extrudate 2100E-2100J as illustrated in FIG. 21), which could also obtain a flat “sheet” if the initial forms being spread or unfolded by some means. It should be noted that, the “sheet” from traditional rawhide sheet and the sheet shape of beef skin or pork skin widely employed to make a chew fall into the aforementioned narrow sense of “sheet”. Thus, an artificial composition material formed into the form of aforementioned “sheet” in narrow sense is considered a good imitation of the natural shape of traditional rawhide sheet (e.g., the beef rawhide and pork rawhide) as a popular chew material. In a broad sense, the term of “sheet” refers to a thin material, which is thin in comparison to its length and breadth, typically in a square or rectangular shape, the sides of which may be smooth or textured, or ribbed (for example, a side of a sheet has a longitudinal ridge or rib on surface; refer to the sheet extrudates as illustrated in 2100C and 2100D in FIG. 21; 2100D has two longitudinal ridges and would get a kind of ribbed sheet if more similar ridges being applied); a sheet under the broad sense may alternatively have an edible coating layer or basting layer on a side of the sheet and since the coating layer or basting layer is subject to be inseparable by hand or is not subject to peel off from the sheet, coating layer or basting layer is generally considered a part of the sheet itself and coated sheet as a whole still well falls into the definition of “sheet” in broad sense. The term of “sheet” in the present disclosure in majority circumstances may refer to the aforementioned narrow sense while it may follow the aforementioned broad sense in others. For example, the “sheet(s)” generated by extruder die designs of 2100A, 2100B, 2100E, 2100F, 2100G, 2100H, 2100I and 2100J as illustrated in FIG. 21 may refer to a sheet in the narrow sense), whereas the “sheet(s)” of 2100C and 2100D may refer to a sheet in the broad sense instead. A “sheet” may come as a distinct and separate component together with another separate component to form a pet chew. For example, a rawhide sheet (as a separate component) and a chicken jerky strip are combined by placing them together and manually knotting them into a rawhide chew. A “sheet” may alternatively come as an inseparate segment of a distinct component to form a pet chew combining another segment, where the two segments are attached to each other firmly as one. For example, a stick shaped extrudate component having an outer layer segment in a sheet form and an inner layer is formed integrally by co-extrusion and the component is then manually re-shaped into a spiral shaped chew.

The term of “tube” (or “tubular”, or “pipe”, or tube-formed, or tubular extrudate) in the present disclosure generally refers to a long hollow object that may be round or not, whose cross-section shape may be various as desired. A typical cross-section of the tube/pipe is in a round (circular) outline (profile) shape, an O-shape, or in a closed-circle outline (profile) shape, or in a closed-curve outline (profile) shape. The outline (profile) shape of the tube's/pipe's cross-section may be in other various shapes, such as an oval shape, a rounded-triangular shape, a rounded-rectangular shape, a polygonal shape, a shape resembling Arabic numerals “8” (twin-tube form), a shape of three-circle (a triple-tube form shape), a shape of water-drop icon, and irregular shapes. A tube has an opening at each end. Typically, the average wall thickness of it ranges from to 0.2 mm to 20 mm (more typically 0.3 mm to 5 mm). Typically, the average wall thickness of a tube to the average diameter of the whole tube is in a proportion no greater than 1:3, which could make its hollow core form fairly distinguishable in appearance (a hollow core plays an important role in the definition of a tube). In some embodiments of the present disclosure, the exterior surface of the tube has a fin part running along the length of the tube, forming a finned tubular component. A tube/pipe without fin part may be referred to as “traditional/common/ordinary/normal tube/pipe” or “traditional/common/ordinary/normal tubular component” in the disclosure. A “tube” may alternatively have an edible coating layer or basting layer on a surface of the tube and since the coating layer or basting layer is subject to be inseparable by hand or is not subject to peel off from the tube, coating layer or basting layer is generally considered an inseparable part of the tube itself and coated tube as a whole still well falls into the aforementioned definition of “tube”, where the material(s) forming the coating or basting layer is considered a part of the ingredient(s) forming the “tube”. The quality of “durable” in the present disclosure generally refers to a feature of a chew or a chew component material that is in a certain durability, and/or rigidity/hardness, and/or elasticity, and/or toughness/flexibility, which can endure a dog's (fairly) long time chewing after its being served to a dog and before it is swallowed. The elements of “finned tubular component”, “extruded traditional tubular component” or “extruded sheet” described in the present disclosure may be a “durable” one. The hardness of them may typically range from Shore D 15 to 65. “Tensile strength” may be used as another particular specification to describe “durable” quality of a material. The typical tensile strength of the elements of “finned tubular component”, “extruded traditional tubular component” or “extruded sheet” may be at least 0.5 mPa, more typically 0.5 mPa to 5 mPa.

In order to achieve a “durable” tubular chew component, the chew component may be formulated intentionally and carefully. According to the inventor's tests, “collagen constituent” or “naturally-collagen-rich” material introduced into the recipe of a collagen-based composition material can facilitate the durability achievement. In an embodiment of the present disclosure, it is to provide an edible pet chew including an artificial dehydrated pizzle component formed from a finned tubular extrudate, a plain tube extrudate or an extruded sheet extrudate made of a collagen-based composition material, where the component in composition has a collagen material and/or naturally-collagen rich material.

To determine the proportion of “collagen (constituent)” or “naturally-collagen-rich material” in a collagen-based material, tests are conducted by the inventor. Refer to “Table I” below titled “Table 1: Durability tests for chew composition with various collagen constituents”. In the tests, a group of composition materials in a formula with a range of “collagen constituent” proportions are involved, ranging from 5% to 32% (No. 2-18 compositions). Among them, the No. 1 composition does not have any collagen constituent, utilized as a starting point of “chew durability”, i.e., 8.1 minutes chewing time durability as indicated therein, thus providing “chew durability” comparisons to other compositions with various collagen constituents. The No. 2-18 compositions following it contain gradually increasing proportions of collagen ranging from 5%-32%. And the collagen constituent from the various compositions of No. 2-18 compositions can be substantially equally obtained by converting them to “corium layer of beef skin” compositions respectively as listed in the column of “Proportion of “corium layer of beef skin” (ground form) in formula” as indicated in Table 1. Taking No. 14 composition as an instance, it contains 25% collagen in the composition, when “corium layer of beef skin” (corium layer of beef skin as a naturally-collagen-rich material having approximately 83% collagen constituent) is employed to provide collagen to a similar composition constitution, the composition having 30% “corium layer of beef skin” will get about 25% collagen which is substantially equal to No. 14 composition.

TABEL 1

| | | Proportion | | |
|---|---|---|---|---|
| | | of Collagen | | |
| | | constituent | | |
| | | (in the | | |
| | Proportion | composite | | |
| | of “corium | of the | | |
| | layer of | chews | | Chew |
| Number- | beef skin” | composed | | Dura- |
| ing of | (ground | of an | | bility* |
| compo- | form) in | extruded | Ingredient | (unit: |
| sitions | formula | tube) | List | minutes) |
| 1 | | 0% | 0% collagen, 60% plant, | 8.1 |
| | | | 25% chicken breast, 15% | |
| | | | chemicals (glycerin, | |
| | | | sorbitol) | |
| 2 | | 5% | 5% collagen, 60% plant, | 7.8 |
| | | | 20% chicken breast, 15% | |
| | | | chemicals (glycerin, | |
| | | | sorbitol) | |
| 3 | | 7% | 7% collagen, 60% plant, | 8.2 |
| | | | 18% chicken breast, 15% | |
| | | | chemicals (glycerin, | |
| | | | sorbitol) | |
| 4 | | 8% | 8% collagen, 60% plant, | 8.7 |
| | | | 17% chicken breast, 15% | |
| | | | chemicals (glycerin, | |
| | | | sorbitol) | |
| 5 | | 9% | 9% collagen, 60% plant, | 8.5 |
| | | | 16% chicken breast, 15% | |
| | | | chemicals (glycerin, | |
| | | | sorbitol) | |
| 6 | | 10% | 10% collagen, 60% plant, | 10.8 |
| | | | 15% chicken breast, 15% | |
| | | | chemicals (glycerin, | |
| | | | sorbitol) | |
| 7 | | 11% | 11% collagen, 60% plant, | 10.7 |
| | | | 14% chicken breast, 15% | |
| | | | chemicals (glycerin, | |
| | | | sorbitol) | |
| 8 | | 13% | 13% collagen, 60% plant, | 11 |
| | | | 12% chicken breast, 15% | |
| | | | chemicals (glycerin, | |
| | | | sorbitol) | |
| 9 | | 14% | 14% collagen, 60% plant, | 12.6 |
| | | | 11% chicken breast, 15% | |
| | | | chemicals (glycerin, | |
| | | | sorbitol) | |
| 10 | 20% | 15% | 15% collagen, 60% plant, | 12.5 |
| | | | 10% chicken breast, 15% | |
| | | | chemicals (glycerin, | |
| | | | sorbitol) | |
| 11 | | 16% | 16% collagen, 60% plant, | 12.5 |
| | | | 9% chicken breast, 15% | |
| | | | chemicals (glycerin, | |
| | | | sorbitol) | |
| 12 | | 22% | 22% collagen, 60% plant, | 13.3 |
| | | | 3% chicken breast, 15% | |
| | | | chemicals (glycerin, | |
| | | | sorbitol) | |
| 13 | | 24% | 24% collagen, 60% plant, | 13.8 |
| | | | 1% chicken breast, 15% | |
| | | | chemicals (glycerin, | |
| | | | sorbitol) | |
| 14 | 30% | 25% | 25% collagen, 60% plant, | 16.5 |
| | | | 0% chicken breast, 15% | |
| | | | chemicals (glycerin, | |
| | | | sorbitol) | |
| 15 | | 27% | 27% collagen, 58.4% | 15.3 |
| | | | plant, 0% chicken breast, | |
| | | | 14.6% chemicals | |
| | | | (glycerin, sorbitol) | |
| 16 | | 28% | 28% collagen, 57.6% | 17.1 |
| | | | plant, 0% chicken | |
| | | | breast, 14.4% | |
| | | | chemicals (glycerin, | |
| | | | sorbitol) | |
| 17 | | 30% | 30% collagen, 56% | 25.3 |
| | | | plant, 0% chicken | |
| | | | breast, 14% | |
| | | | chemicals (glycerin, | |
| | | | (glycerin, sorbitol) | |
| 18 | | 32% | 32% collagen, 54.4% | 24.9 |
| | | | plant, 0% chicken | |
| | | | breast, 12.6% | |
| | | | chemicals (glycerin, | |
| | | | (glycerin, sorbitol) | |

Remarks:
″Tabel 1: Durability tests for chew composition with various collagen constituents″
Specification of tested bones: size-4.5″, weight-55 g
Testing dog: French bulldog, weight 24 lbs, aged 4
*Minutes counted from the first bite until its being completely swallowed

According to the tests from Table 1 above, when the collagen (constituent) proportion increases to 10% (No. 6 composition), an over ⅓ longer “durability” than No. 1 composition is observed. When the collagen proportion increases to 15% (No. 10 composition), an over ½ “durability” than No. 1 composition is observed. When the collagen proportion increases to 25% (No. 14 composition), a double “durability” chewing time of No. 1 composition is observed. When the collagen proportion increases to 30% (No. 17 composition), a triple “durability” chewing time of No. 1 composition is observed. Based on the tests, the collagen-based composition of the present disclosure is supposed to have over 10% collagen constituent in formula. And typically, the collagen-based composition has over 25% (more typically over 30%) collagen constituent. And in the scenarios that a naturally-collagen-rich material (having over 50% collagen constituent), the collagen-based composition of the present disclosure is supposed to have over 20% naturally-collagen-rich materials in formula. And more typically, the collagen-based composition has over 30% naturally-collagen-rich materials in formula.

The term of “starch” in the present disclosure generally refers to a carbohydrate food substance obtained from a plant. Some examples include starches derived from potato, sweet potato, mung bean, wheat, corn, tapioca, rice, pea, and mixtures thereof. The starch can be used in its native form, but it may also be physically or chemically modified before being applied. Of course, it is also possible to use combinations of native starch and modified starch, or combinations of different modified starches.

It should be noted that the term “plant” in the present disclosure generally refers to an edible part of a plant or an edible material derived from a plant, where the plant material includes, but not limited to: a plant material (such as potato, sweet potato, mung bean, wheat, corn, tapioca, rice, pea, soybean, peanut, almond, mushroom, legumes, beans, grains, chia seed, algae, seaweed, spirulina, cereals and mixtures thereof), a material of edible part of a plant, a plant derived material, a plant protein, a plant starch, a plant fiber, a vegetable material, a vegetable derived material, a vegetable protein, a vegetable starch and mixtures thereof. Gluten-free plant and gluten-free vegetables are some typical materials to form the “plant ingredient” since gluten materials are considered by experts in this industry as the ones that could potentially make dogs allergic. Examples of gluten-free plant material are tapioca, soybean, sweet potato, potato and carrot.

The term of “plant-based” refers to a composite (or composition) material including substantially at least 50% plant ingredient(s) by weight in the formula. Usually, all plant ingredients (such as plant starch, plant protein, and plant fibers) existing in the “plant-based” composite/composition added together account for the number one proportion ingredient(s) in the material by weight, which is larger than any other individual (or single) non-plant ingredient existing in the material, such as glycerin, chicken, chicken liver, sugar, and sorbitol. Non-plant ingredient(s) existing in the material may be any one of: meat (meat by-product) ingredient, rawhide-free animal skin ingredient, animal skin corium layer ingredient, naturally collagen-rich materials, chemicals and a combination thereof. Preferably, a plant-based material of the present disclosure is free of rawhide ingredients. Alternatively, a plant-based composition material in the present disclosure may have 2%-35% humectant (more typically 10%-25% humectants; humectants such as glycerin, sorbitol) ingredients as a kind of chemical in addition to plant ingredient.

“Animal ingredient” refers to the materials obtained from a slaughtered animal (such as vertebrate animal, livestock animal, bovine, porcine, ovine, caprine, poultry and fish), including meat, meat by-product (including animal skin) or a combination thereof, other than feather, horn, hair, teeth, hooves. The term of “meat” generally refers to the clean flesh derived from slaughtered animals (including but not limited to mammals, livestock, bovine, porcine, cattle, pig, poultry, chicken, duck, turkey and fish) and is limited to that part of the striate muscle which is skeletal or that part which is found in the tongue, in the diaphragm, in the heart or in the esophagus; with or without the accompanying and overlying fat, sinew, nerve and blood vessels which normally accompany the flesh. In other words, “meat” may refer to primarily the muscle tissue of an animal. Exemplary materials include poultry flesh, bovine flesh, ovine flesh, caprine flesh, turkey flesh, chicken flesh, beef, pork, and fish flesh. The term of “meat by-product(s)” in the present disclosure generally may refer to (preferably non-rendered) clean parts, other than meat, derived from slaughtered animals (such as mammals, fish, and poultry), which includes, but is not limited to skin, cartilage, trachea, animal ear, poultry foot, esophagus, animal pizzle, gelatin, ligament, pericardium, tendon, lungs, spleen, kidneys, brain, livers, blood, bone, partially defatted low-temperature fatty tissue, stomachs and intestines free of their contents and a combination thereof “Meat by-product” may also be a material selected from the group consisting of: corium (dermis) layer of skin, eggshell membrane, milk, milk powder, milk-derived material, cheese, cheese-derived material, whey, whey protein powder, whey-derived material, egg, and egg-derived material. Some other exemplary materials are chicken liver, bovine tendon, bovine lungs, porcine fat, beef bone powder and pig stomach. The term of “meat-based” in the present disclosure may refer to a composition material having 30%-99% (typically 30%-60%) meat (or meat by-product, or a combination of meat and meat by-product) ingredient by weight on an as formulated basis or on an as fed basis and 20%-50% plant ingredient by weight on an as formulated basis or on an as fed basis. Alternatively, a meat-based (or a meat by-product-based) composition material in the present disclosure may have 2%-35% humectant (more typically 10%-25% humectants; humectants such as glycerin, sorbitol) ingredients as a kind of chemical in addition to meat (or meat by-product) ingredient.

“Attractant” material (it may also be referred to as flavor material) in the present disclosure may refer to a material having a flavor that is applied to entice pets/dogs to chew on and eat. Examples of the attractant are chicken liver, hydrolyzed animal protein, hydrolyzed chicken liver, poultry digest, chicken digest, artificial beef flavor, artificial pork flavor, meat ingredient, meat by-product ingredient, and brewer yeast.

It should be noted that the term “assemble” means to fit together all separate parts/members/components of a pet chew product. For example, several separate components of a pet chew are manipulated (such as knotting, wrapping, stuffing, rolling, folding, braiding, and twisting) by hand or by machine to have the components together form a pet chew product in a predetermined relationship.

Artificial Dehydrated Pizzle (or artificial bully stick, or Pizzle-like) pet chew of the present disclosure imitating or approximating genuine bully stick is now being introduced to serve as an alternative to aforementioned traditional (genuine) Bully Sticks, with significantly lower product cost, imitating or approximating some necessary properties or features (at least including shape or appearance features) of a dehydrated bovine pizzle (traditional bully stick). Artificial Dehydrated Pizzle (or artificial bully stick) pet chew as illustrated in the disclosure is well distinguished from traditional Bully Sticks (dehydrated bovine pizzle), where the former typically is formed from an extrudate (or injection-moulding, cast moulding or compression moulding) (the extrudate initially may be in a stick form before being reshaped into final end product shape) formed of a composition material having collagen or naturally-collagen-rich ingredient. As a contrast, dehydrated bovine pizzle (traditional bully stick) is substantially a single ingredient product primarily without being processed other than dehydrating process.

One advantage of the Artificial Dehydrated Pizzle (or artificial bully stick) pet chew of the present disclosure is its significantly cheaper material cost than dehydrated bovine pizzle (traditional bully stick). The Artificial Dehydrated Pizzle (or artificial bully stick) pet chew is extremely cheaper than dehydrated bovine pizzle (traditional bully stick) which is made of substantially 100% bovine pizzle. The latter could be 4 times of the price of the former. Due to the natural scarcity property with the source of natural bovine pizzle, raw materials (bovine pizzle) for producing traditional bully sticks (dehydrated bovine pizzle) are sold at an extremely high price, which results in the final products, traditional bully sticks (dehydrated bovine pizzle), being sold to consumers at an extraordinarily high price. Another advantage is the easier acquisition of raw material versus dehydrated bovine pizzle (traditional bully stick) products. Producing dehydrated bovine pizzle (traditional bully stick) products requires huge volume of natural animal pizzle. In one embodiment, the Artificial Dehydrated Pizzle (or artificial bully stick) pet chew of the present disclosure is formed from a composition with meat-by-product ingredient (for example pizzle). For example, the composition has 10% pizzle in formula (90% is non-pizzle ingredient which is extremely acquisition-easier material than pizzle), in which producing this product just requires one tenth of pizzle material to manufacture the same quantity of finished products versus dehydrated bovine pizzle (traditional bully stick) products. Preparing the composition materials for production of Artificial Bully Stick pet chew is much easier than that for production of traditional bully sticks (dehydrated bovine pizzle).

Another advantage of the Artificial Dehydrated Pizzle pet chew (having a collagen-based artificial dehydrated pizzle component) of the present disclosure is its favorable collagen content. A traditional bully stick may inherently have 2%-5% collagen constituent/element in the material, however, the Artificial Dehydrated Pizzle component may introduce over 10% collagen constituent (element or ingredient) in it.

In some embodiments, the Artificial Dehydrated Pizzle (or artificial bully stick, or Pizzle-like) pet chew (or pet chew member) of the present disclosure includes an outer layer member/portion and an inner member (the outer layer and inner layer may either be integrally formed by co-extrusion, or be of separate parts), where the former holds the latter by surrounding it, in a purpose to imitate or approximate a typical feature of traditional Bully Sticks (dehydrated bovine pizzle). In some embodiments, the thickness of the outer layer is substantially homogenous along the whole stick body, as that of a dehydrated bovine pizzle (traditional bully stick) does. Typical thickness of the outer layer is 0.3 mm-5 mm. As shown in FIG. 1, 0100A is pet chew with outer layer (mono-extruded) of 0101 and inner member (filled into the case 0104 formed by component 0101) of 0102. And 0200B is a pet chew with outer layer of 0205 and inner member of 0206 formed by co-extrusion. Typically, the outer layer 0101 or 0205 serves as an outer casing for the pet chew surrounding the inner member, together forming a chew.

Cross-section outline shapes of Artificial Bully Stick (bully stick analogue) pet chews of the present disclosure may resemble the cross-section outline shapes of natural Bully Sticks, with a purpose to imitate or approximate Bully Sticks. Natural bully sticks have various cross-section outline shapes which are inherently determined by raw material of pizzle. In one embodiment, cross-section of an Artificial Bully Stick pet chew (artificial-bully-stick member) of the present disclosure is in an outline shape substantially similar to capital letter “B”, or cashew nut (icon), or peanut (icon), or heart icon, or Arabic numeral “8”, imitating/approximating a typical cross-section outline shape of traditional bully sticks as aforementioned. These typical outline shapes of the Artificial Bully Stick (shapes that are similar to capital letter “B”, or cashew nut (icon), or peanut (icon), or heart icon, or Arabic numeral “8”) have a common feature, where the outline shapes have a “trough” area that is significantly lower than the surface. The “trough” appearing on the outline shapes are created by aforementioned “groove” that runs longitudinally along the Artificial Bully Stick body. These specific cross-section outline shapes (shapes that are similar to capital letter “B”, or cashew nut (icon), or peanut (icon), or heart icon, or Arabic numeral “8”) with distinct “trough” part may well fulfill the natural bully stick imitation purposes. As shown in FIG. 11, cross-section profiles 1100A-1100F illustrate a group of six alternative cross-section outline shapes for six co-extruded Artificial Dehydrated Pizzle components of pet chews according to the present disclosure respectively. The shape of 1100A and 1100B both are similar to a peanut icon. And the shapes of 1100C, 1100D, 1100E and 1100F resemble cashew nut icon, Arabic numeral “8”, heart icon and capital letter “B” respectively. The cross-section shapes of the artificial bully sticks as illustrated in FIGS. 1-4, 6, 9, 10 and 19 resemble a capital letter “B”. As shown in FIG. 2, 0200A is an extruded pet chew with a typical cross-section outline shape similar to capital letter “B” corresponding to the cross-section outline shape 1100F from FIG. 11, with a purpose to imitate a typical cross-section outline shape of traditional bully sticks. And in some other alternative embodiments, the cross-section outline shape of pet chew 0200A from FIG. 2 may be replaced by other desired shapes such as 1100A, 1100B, 1100C, 1100D and 1100E as illustrated in FIG. 11. Similarly, in some other embodiments, the cross-section outline shape of chews from FIGS. 1-10 and 19 may be replaced by the shapes as illustrated in FIGS. 11 and 12 correspondingly according to desire.

Some other alternative cross-section outline shapes for the Artificial Dehydrated Pizzle (or artificial bully stick, or Pizzle-like) pet chew can imitate the various ones that a natural dehydrated bovine pizzle (traditional bully stick) may feature with (FIGS. 17 and 18 may be also referred to as some various cross-section outline shape of a traditional bully stick).

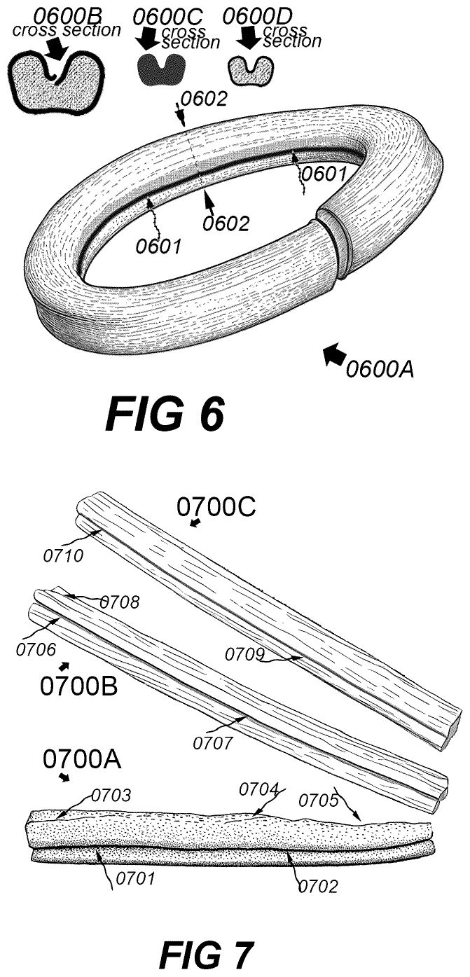

In one preferred embodiment, an Artificial Dehydrated Pizzle (or artificial bully stick) pet chew (or pet chew member) of the present disclosure has a (built-in) groove form longitudinally running along a part of or whole of the artificial dehydrated pizzle body on the surface of the Artificial dehydrated pizzle (member), with a purpose to imitate or approximate a typical inherent groove of dehydrated bovine pizzle (traditional bully stick) products. More typically, the groove is a continuous one longitudinally through the full length of the stick body appearing on the surface of the stick body. It should be noted that, there are various shapes/structures/appearance that genuine bull stick products may possess, which makes it hard to identify a common structural feature. The present applicant surprisingly discloses that, “groove” is a key feature that the Artificial Bully Sticks (or artificial dehydrated pizzle) products should possess to imitate or approximate genuine bully stick appearance although it is understood that genuine bully sticks have various shapes/structures and various cross-section shapes. This disclosure discloses a perfect and easy imitation method to imitate dehydrated bovine pizzle (traditional bully stick) appearance. Additionally, the form of “groove” appearing on the pet chew may provide extra benefits of tooth cleaning action, where the groove form may accommodate dog tooth configurations and have it slide along the two walls of the groove while being gnawed by a dog, and thus tartar or dental plaque may be mechanically removed hereby. A typical groove depth of the Artificial Dehydrated Pizzle (or artificial bully stick) is at least 1 mm as that of a genuine bully stick does. Typically, the depth of a groove of the Artificial Bully Stick accounts for at least 10% of the thickness of the Artificial Dehydrated Pizzle. A depth accounting for “10% of the thickness” may be the least one that makes a groove noticeable to consumers when it appears on a surface of the artificial dehydrated pizzle component. Refer to FIG. 1, 0100D is a pet chew made of extruded sheet with a groove 0113 along the stick body imitates or approximates natural Bully Sticks, which is formed by extruder die with pre-designed configuration forming a rolled sheet directly (without manual rolling process) and a groove in a single extruding process or by manipulating an extruded flat sheet to a rolled sheet to form a cylindrical configuration with a groove on the surface. Refer to FIG. 2, 0200A is a pet chew made of co-extruded stick with a groove 0203 on the surface along the stick body imitates or approximates natural Bully Sticks, which is formed by extruder die with pre-designed shape. As shown in FIG. 11, 1101-1109 refer to nine “trough” areas that refer to 9 troughs (grooves) in the six different cross-section shapes of pet chews according to the present disclosure. 0303 from FIG. 03, 0501/0502 from FIG. 5, 0601 from FIGS. 6 and 1003 from FIG. 10 refer to a groove form existing in the pet chews according to the present disclosure, where the grooves are continuous ones longitudinally through the whole length of the stick bodies. But in some embodiments, a “groove” may not be continuous ones, which runs at a partial length of the chew on surface.

In some embodiments, inner layer color of the Artificial Dehydrated Pizzle (or artificial bully stick, or Pizzle-like) pet chew of the present disclosure is comparatively lighter than outer layer color, as genuine bully stick does. Now refer to chew 0200A in FIG. 2 as an example, it is an extruded pet chew with inner layer of 0202 is lighter than outer layer 0201. Inner layer color is typically white or yellowing white. Outer layer color is typically light brown, brown, dark brown, red brown or muscle color.

In one embodiment, an entire body or a part of the outer layer of the Artificial Dehydrated Pizzle (or artificial bully stick, or Pizzle-like) component of the present disclosure is translucent where inner member inside is a bit visible through the outer layer, in a purpose to imitate or approximate a typical outer layer appearance of traditional Bully Sticks (dehydrated bovine pizzle).

And in one embodiment, the outer layer of an artificial dehydrated pizzle pet chew according to the present disclosure presents fiber-like texture, in a purpose to imitate or approximate a typical outer layer texture of traditional Bully Sticks (dehydrated bovine pizzle). The thickness of outer layer of the Artificial Dehydrated Pizzle (or artificial bully stick) of the present disclosure is typically 0.3 mm-5 mm, imitating or approximating the thickness feature of dehydrated bovine pizzle (traditional bully stick) products.

In one embodiment, inner member of the Artificial Dehydrated Pizzle (or artificial bully stick) pet chew of the present disclosure has a bubble, blister, pores or air-filled cavity (numerous bubbles, blisters, pores or air-filled cavities), being, intended to imitate or approximate the appearance/texture of inner part of dehydrated bovine pizzle (traditional bully stick) that is formed by tissues of corpus cavernosum and/or spongiosum. Alternatively, there are edible-granule-formed materials appearing in the inner member (creating visual illusion of pore-like forms), being intended to visually imitate or approximate the appearance/texture of inner part of dehydrated bovine pizzle (traditional bully stick) that is formed by tissues of corpus cavernosum and/or spongiosum. In one embodiment, these tiny bubbles or edible-granule-formed materials spread (substantially homogeneously) to the inner member material, forming the inner member a porous material. As shown in FIG. 3, 0300 is an extruded pet chew whose inner part 0302 may further include air bubbles or edible-granule-formed materials spread evenly into the inner part. As shown in FIG. 19, 1900 is a pet chew having an artificial bully stick component formed from a single piece of material and formed by mono-extrusion whose inner part 1902 includes air bubbles or edible-granule-formed materials spread into the inner part. In one embodiment, inner member of the Artificial Dehydrated Pizzle (or artificial bully stick) pet chew of the present disclosure is comparatively more unconsolidated or looser in texture than the outer layer. As shown in FIG. 2, 0200B is an extruded pet chew with inner member 0206 comparatively looser than muscle outer layer 0205.

In some embodiments of the present disclosure, it is to provide an edible pet chew including an artificial dehydrated pizzle component formed from a collagen-based composition and having a groove running longitudinally on the surface of the component in final end product, where the component is formed from an extrudate (either mono-layered extrudate or multi-layered extrudate) produced by extrusion process, and where the extrudate may be further shaped into final product configuration/shape/structure/form such as the shapes of a knotted bone, a twisted stick, a ring, a spiral, a spring, a curl and a braid.

In one aspect of the present disclosure, it is to provide an edible pet chew including an artificial dehydrated pizzle component formed from a collagen-based composition and having a groove running longitudinally on the surface of the component in final end product, where the component is formed from a mono-layered extrudate produced by extrusion (mono-extrusion) process, and where the extrudate may be further shaped into final product configuration/shape/structure/form such as the shapes of a knotted bone, a twisted stick, a ring, a spiral, a spring, a curl and a braid. It's foreseen that, though mono-layered extrudate employed in some embodiments of the present disclosure may be an optimal option to implement this aspect of present disclosure in view of cost, multi-layered extrudate in the same intended extrudate profile may also work to replace if different appearance on the single extrudate is desired.

In some embodiments of the present disclosure according to the aspect, a pet chew is provided including an artificial dehydrated pizzle component formed from a collagen-based composition and having a groove running longitudinally on the surface of the component in final end product, where the component is formed from a mono-layered extrudate in a cylinder/stick/rod form produced by extrusion (mono-extrusion) process, and where the extrudate component in the cylinder/stick/rod form may be further manipulated or re-shaped into final product configuration/shape/structure/form such as the shapes of a knotted bone, a twisted stick, a ring, a spiral, a spring, a curl and a braid. Refer to FIG. 2, mono-extruded solid cylinder-formed collagen-based artificial dehydrated pizzle pet chew 0200D is shown formed form a mono-layered extrudate 0215 and having a cross-sectional profile 0213 resembling letter “B” and a groove part 0214 on the surface. This chew configuration may also be fulfilled by employing multi-layered extrudate instead as shown at pet chew 0200C in FIG. 2. The co-extruded solid cylinder-formed collagen-based artificial dehydrated pizzle pet chew 0200C is formed form a multi-layered extrudate 0212 (layer 0209 and 0210) and has a cross-sectional profile of letter “B” and a groove part 0211 on the surface. The artificial dehydrated pizzle component 0600A from FIG. 6 may also be formed from a collagen-based tubular mono-layered extrudate with a cross-section profile 0600C, alternatively.

In some embodiments of the present disclosure according to the aspect, a pet chew is provided including an artificial dehydrated pizzle component formed from a collagen-based composition and having a groove running longitudinally on the surface of the component in final end product, where the component is formed from a mono-layered extrudate in a tube form (or in a finned tubular component form) produced by extrusion (mono-extrusion) process, and where the extrudate component may be further manipulated or re-shaped into final product configuration/shape/structure/form such as the shapes of a knotted bone, a twisted stick, a ring, a spiral, a spring, a curl and a braid. Optionally, an additional edible material serving as a second component may be introduced to fill the hollow part of the extrudate being surrounded, positioned in or wrapped in by the extrudate, such as chicken breast-based slurry and a cylindrical plant-based extrudate. The second component may alternatively be a porous material (typically formed from a plant-based material or a collagen-based material) wrapped in the first component.

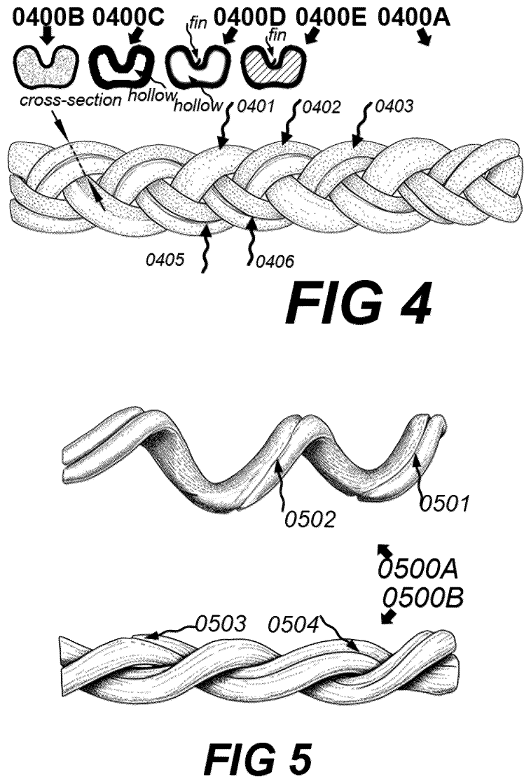

Refer to FIG. 1, mono-extruded tubular collagen-based artificial dehydrated pizzle pet chew 0100B is shown formed form a mono-layered extrudate 0107 and having a cross-sectional profile 0100F resembling letter “B” and a groove part 0106 on the surface. 0105 refers to an end of the extrudate. Another mono-extruded tubular artificial dehydrated pizzle pet chew 0100A is shown formed form a mono-layered extrudate 0104 and having a cross-sectional profile 0100E resembling letter “B” and a groove part 0103 on the surface. 0101 refers to an end of the extrudate. The artificial dehydrated pizzle components 0401/0402/0403 from FIG. 4 may also be formed from a collagen-based tubular mono-layered extrudate with a cross-section profile 0400C, alternatively.

Refer to FIG. 8, mono-extruded tubular collagen-based artificial dehydrated pizzle pet chew 0800 is shown formed form a mono-layered extrudate (dual-hole tube) and having a cross-sectional profile resembling Arabic number “8” and a groove part 0804 on the surface. 0801 refers to an end of the extrudate.

In one embodiment of the present disclosure, an Artificial Bully Stick member of the pet chew product is formed from a collagen-based tubular extrudate has at least two holes (holes refer to hollow spaces in it) through the full length of it. As shown in FIG. 8, pet chew product 0800 in stick configuration refers to an embodiment of the present disclosure with two holes running through the length of pet chew 0800 with two openings on both ends. 0800 is formed from a single piece of material. A cross-section of pet chew 0800 is in a shape resembling Arabic numeral “8”. 0804 refers to a groove on the surface running longitudinally through the full length of the pet chew 0800.

Stuffing 0102 as an additional edible material (serving as a second component) is filled into the casing formed by mono-layered extrudate 0104, being surrounded, positioned in or wrapped in by it. Optimally, the pet chew 0100A is made of a collagen-based composition as a whole combining the outer layer and the inner. In the circumstance that pet chew 0100A is made of a collagen-based composition as a whole, optimally, mono-layered extrudate 0104 is made of a collagen-based composition, but optionally, it could be done by a plant-based composition and more collagen constituent would be found in the recipe of the stuffing 0102.

The artificial dehydrated pizzle components 0401/0402/0403 from FIG. 4 may also be formed from a collagen-based finned tubular mono-layered extrudate with a cross-section profile 0400D, alternatively. The “fin” positioned the bottom of the groove is pointed therein by an arrow.

In some embodiments of the present disclosure according to the aspect, a pet chew is provided including an artificial dehydrated pizzle component formed from a collagen-based composition and having a groove running longitudinally on the surface of the component in final end product, where the component is formed from a mono-layered extrudate in a Sheet form (or in a rolled sheet form, or in a curved sheet form) produced by extrusion (mono-extrusion) process, and where the extrudate component may be further shaped into final product configuration/shape/structure/form such as the shapes of a knotted bone, a twisted stick, a ring, a spiral, a spring, a curl and a braid. Optionally, an additional edible material serving as a second component may be introduced to fill the hollow part of the extrudate being surrounded, positioned in or wrapped in by it, such as chicken breast-based slurry and a cylindrical plant-based extrudate. The second component may alternatively be a porous material (typically formed from a plant-based material or a collagen-based material) wrapped in the first component. The mono-layered sheet extrudate may initially be a substantially-flat sheet defined by the extruder die design, then the sheet extrudate be manipulated (by bending, rolling up, or curving) by hand or machine into a bended, rolled or curved sheet form in a cylinder/stick/rod shape as a whole creating a groove part running longitudinally on the surface, and then the sheet extrudate be, if applicable, further manipulated or reshaped into final end product shape such as a spiral shape, a ring shape and a knotted bone shape. Alternatively, the mono-layered sheet extrudate may initially be a bended, rolled or curved sheet form defined by the extruder die design, in a cylinder/stick/rod shape as a whole with a groove part running longitudinally on the surface, and then the (bended, curved or rolled) sheet extrudate be, if applicable, further manipulated or reshaped into final end product shape such as a spiral shape, a ring shape and a knotted bone shape.

Refer to FIG. 1, collagen-based mono-extruded extruded sheet artificial dehydrated pizzle pet chew 0100D is shown formed form a mono-layered sheet extrudate 0114 and having a cross-sectional profile 0100H resembling letter “B” and a groove part 0113 on the surface. 0112 refers to an end of the extrudate. Another mono-extruded sheet artificial dehydrated pizzle pet chew 0100C is shown formed form a mono-layered sheet extrudate 0111 and having a cross-sectional profile 0100G resembling letter “B” and a groove part 0110 on the surface. 0108 refers to an end of the extrudate.

Stuffing 0109 as an additional edible material (serving as a second component) is filled into the casing formed by mono-layered extrudate 0111, being surrounded, positioned in or wrapped in by it. Optimally, the pet chew 0100C is made of a collagen-based composition as a whole combining the outer layer and the inner. In the circumstance that pet chew 0100C is made of a collagen-based composition as a whole, optimally, mono-layered extrudate 0111 is made of a collagen-based composition, but optionally, it could be done by a meat-based composition and more collagen constituent would be found in the recipe of the stuffing 0109.

In another aspect of the present disclosure, it is to provide an edible pet chew including an artificial dehydrated pizzle component formed from a collagen-based composition and having a groove running longitudinally on the surface of the component in final end product, where the component is formed from a multi-layered extrudate produced by extrusion (co-extrusion) process, and where the extrudate may be further manipulated or re-shaped into final product configuration/shape/structure/form such as the shapes of a knotted bone, a twisted stick, a ring, a spiral, a spring, a curl and a braid. It's foreseen that, though multi-layered extrudate employed in some embodiments of the present disclosure may be a desired option to implement this aspect of present disclosure if different appearance on the single extrudate is desired, mono-layered extrudate in the same intended extrudate profile may also work to replace if cost concerns are a priority.

In some embodiments of the present disclosure according to the aspect, a pet chew is provided including an artificial dehydrated pizzle component formed from a collagen-based composition and having a groove running longitudinally on the surface of the component in final end product, where the component is formed from a multi-layered extrudate, where each layer of the extrudate is in a cylinder/stick/rod form produced by extrusion (co-extrusion) process, and where the extrudate component in the cylinder/stick/rod form may be further manipulated or re-shaped into final product configuration/shape/structure/form such as the shapes of a knotted bone, a twisted stick, a ring, a spiral, a spring, a curl and a braid. Refer to FIG. 2, co-extruded solid cylinder-formed collagen-based artificial dehydrated pizzle pet chew 0200C is shown formed form a multi-layered extrudate 0215 and having a cross-sectional profile resembling letter “B” and a groove part 0211 on the surface. This chew configuration may also be fulfilled by employing mono-layered extrudate instead as shown at pet chew 0200D in FIG. 2.

In some embodiments of the present disclosure according to the aspect, a pet chew is provided including an artificial dehydrated pizzle component formed from a collagen-based composition and having a groove running longitudinally on the surface of the component in final end product, where the component is formed from a multi-layered extrudate including an outer layer in a tube form (or in a finned tubular component form) produced by extrusion (co-extrusion) process, and where the extrudate component may be further manipulated or re-shaped into final product configuration/shape/structure/form such as the shapes of a knotted bone, a twisted stick, a ring, a spiral, a spring, a curl and a braid. In this configuration, the inner layer segment is surrounded, positioned in or wrapped in by the outer layer, which may have a different composition from the outer layer or have a different texture. The inner layer may alternatively be a porous material (typically formed from a plant-based material or a collagen-based material) wrapped in the outer layer.

Refer to FIG. 2, co-extruded collagen-based artificial dehydrated pizzle pet chew 0200A having an outer layer in a tube form is shown formed form a multi-layered extrudate 0204 and having a cross-sectional profile 0200E resembling letter “B” and a groove part 0203 on the surface, having an outer layer 0201 in a tube form and an inner layer 0202. Another co-extruded artificial dehydrated pizzle pet chew 1000 including a co-extruded artificial dehydrated pizzle component having an outer layer in a tube form is shown formed form a multi-layered extrudate 1010 and having a cross-sectional profile resembling letter “B” and a groove part 1003 on the surface, having an outer layer 1001 in a tube form and an inner layer 1002. The artificial dehydrated pizzle components 0401/0402/0403 from FIG. 4 may also be formed from a collagen-based multi-layered extrudate having an outer layer in a tube form with a cross-section profile 0400B, alternatively. The artificial dehydrated pizzle component 0600A from FIG. 6 may also be formed from a collagen-based multi-layered extrudate having an outer layer in a tube form with a cross-section profile 0600D, alternatively.

Refer to FIG. 4, the artificial dehydrated pizzle components 0401/0402/0403 may also be formed from a collagen-based multi-layered extrudate having an outer layer in a finned tubular form and an inner layer with a cross-section profile 0400E, alternatively.

In some embodiments of the present disclosure according to the aspect, a pet chew is provided including an artificial dehydrated pizzle component formed from a collagen-based composition and having a groove running longitudinally on the surface of the component in final end product, where the component is formed from a multi-layered extrudate including an outer layer in a Sheet form (or in a rolled sheet form, or in a curved sheet form) produced by extrusion (co-extrusion) process, and where the extrudate component may be further shaped into final product configuration/shape/structure/form such as the shapes of a knotted bone, a twisted stick, a ring, a spiral, a spring, a curl and a braid. The inner layer segment may alternatively be a porous material (typically formed from a plant-based material or a collagen-based material) wrapped in the first component. The multi-layered extrudate may have an outer layer segment initially being a bended, rolled or curved sheet form defined by the extruder die design, in a cylinder/stick/rod shape as a whole with a groove part running longitudinally on the surface, and then the extrudate be, if applicable, further manipulated or reshaped into final end product shape such as a spiral shape, a ring shape and a knotted bone shape.

Refer to FIG. 2, a co-extruded artificial dehydrated pizzle pet chew 0200B having an outer layer in a rolled/curved sheet form is shown formed form a multi-layered extrudate 0208 and having a cross-sectional profile 0200F resembling letter “B” and a groove part 0207 on the surface, having an outer layer 0205 in a rolled/curved sheet form and an inner layer 0206. Refer to FIG. 3, a co-extruded artificial dehydrated pizzle pet chew 0300A having an outer layer in a rolled/curved sheet form is shown formed form a multi-layered extrudate 0304 and having a cross-sectional profile 0300B resembling letter “B” and a groove part 0303 on the surface, having an outer layer 0301 in a rolled/curved sheet form and an inner layer 0302. Refer to FIG. 9, a co-extruded artificial dehydrated pizzle pet chew 0900 including an artificial dehydrated pizzle component having an outer layer in a rolled/curved sheet form is shown formed form a multi-layered extrudate 0901 and having a cross-sectional profile resembling letter “B” and a groove part on the surface, having an outer layer in a rolled/curved sheet form and an inner layer. The artificial dehydrated pizzle component 0600A from FIG. 6 may also be formed from a collagen-based multi-layered extrudate having an outer layer in a rolled/curved sheet form with a cross-section profile 0600B, alternatively.

In an embodiment of these, a first layer segment is in a rolled sheet form, where a second layer segment is surrounded, positioned in or wrapped in by the first layer.

In some embodiments of the present disclosure, a pet chew (pet treat) is provided including a first component, an artificial dehydrated pizzle component having a groove running longitudinally on the surface and a second component (an additional edible material). In some embodiments of these, the second component wraps or surrounds the first component. In some embodiments of these, the second component and the first component are assembled in a relationship that the first and second component form alternating layers in that assembly. In some embodiments of these, the second component is wrapped in or surrounded by the first component. In some embodiments of these, the second material is a collagen-rich (naturally-collagen-rich material), such as porcine tendon, turkey cartilage, beef trachea and corium layer of animal skin.

In one embodiment of the present disclosure, an Artificial Dehydrated Pizzle (or artificial bully stick) pet chew is provided with at least two separate Artificial Dehydrated Pizzle (or artificial bully stick) components/members being further manipulated/shaped to a stick shape, a twisted stick configuration, a spiral shape, a curl shape, a pretzel knot, a knotted bone shape, a ring shape or a braided configuration alternatively before being hardened to a final product.

An embodiment of the present disclosure is to provide an edible pet chew including a first Artificial dehydrated pizzle (or Artificial Bully Stick) member and a second edible material member being assembled together.

In one embodiment of the present disclosure, an edible pet chew includes an artificial dehydrated pizzle member (artificial bully stick member) and an additional edible material member of animal pizzle material being assembled together.

In another embodiment of the present disclosure, an edible pet chew includes an Artificial Dehydrated Pizzle member (artificial bully stick member) and an additional edible material member of animal hide material being assembled together.

In yet another embodiment of the present disclosure, an edible pet chew includes an Artificial Dehydrated Pizzle member in a cylindrical form and additional more than one mass-shaped or ball-shaped edible material members being assembled together to have the edible material members attached onto the cylindrical artificial dehydrated pizzle member and spaced, forming a kabob configuration product.

In some embodiments of the present disclosure, it is to provide an edible pet chew (pet treat) including an extruded (ordinary) tube component, or an extruded sheet component, or a tubular component with a fin part (or also be referred to as a finned tubular component) made of a (artificial) composition material, being fairly dural for chewing activities, which can endure a dog's long-time chewing before being swallowed, in which the component in final product may be formed into an artificial dehydrated pizzle component having a groove running longitudinally on the surface.

In some embodiments of the present disclosure, it is to provide an edible pet chew (pet treat) including an artificial dehydrated pizzle component formed from any one of: 1, mono-layered extrudate to form an Artificial Dehydrated Pizzle component (1.1, a mono-extruded tube hollow inside without stuffings; 1.2, a mono-extruded tube filled with stuffings; 1.3, a mono-extruded sheet rolled up into an Artificial Dehydrated Pizzle shape without stuffings; 1.4, a mono-extruded sheet rolled up into an Artificial Dehydrated Pizzle shape filled with stuffings; 1.5, a mono-extruded (rolled/curved) sheet in an Artificial Dehydrated Pizzle shape without stuffings; 1.6, a mono-extruded (rolled/curved) sheet in an Artificial Dehydrated Pizzle shape filled with stuffings; 1.7, a mono-extruded finned tubular component hollow inside without stuffings; 1.8, a mono-extruded finned tubular component filled with stuffings; 1.9, a mono-extruded cylinder/stick/rod extrudate manipulated or reshaped into final end product configuration); 2, multi-layered extrudate to form an Artificial Dehydrated Pizzle component (2.1, a co-extruded tube with an outer layer and an inner layer; 2.2, a co-extruded extrudate in an Artificial Dehydrated Pizzle shape with an outer layer in a sheet form and an inner layer; 2.3, a co-extruded extrudate in an Artificial Dehydrated Pizzle shape with an outer layer in a finned tubular form and an inner layer; 2.4, a co-extruded cylinder/stick/rod extrudate including a first tubular layer and a second inner layer and manipulated or reshaped into final end product configuration; 2.5, a co-extruded cylinder/stick/rod extrudate with a first segment and a second segment combined which is manipulated or reshaped into final end product configuration). The pet chew as a collagen-based chew as a whole contains at least 20% collagen-rich (naturally-collagen-rich) material and/or at least 10% collagen constituent (or element, or ingredient) in final end product counting in the collagen present in every component(s), in which the artificial dehydrated pizzle component in final product has a groove running longitudinally on the surface.

In some embodiments of the present disclosure, an edible pet chew (pet treat) is provided including an extruded sheet component (formed form a sheet extrudate) formed of a collagen-based composite/composition material having at least 20% collagen-rich (naturally-collagen-rich) material by weight and/or at least 10% collagen (constituent, element, or ingredient) by weight, in which the component in final product may be formed into an artificial dehydrated pizzle component having a groove running longitudinally on the surface. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal ear, poultry foot, esophagus, animal pizzle, ligament, pericardium, animal tendon, eggshell membrane, and any combination thereof.

In some embodiments of the present disclosure, an edible pet chew (pet treat) is provided including an extruded (ordinary) tubular component (formed from a tubular extrudate) formed of a collagen-based composite/composition material having at least 20% collagen-rich (naturally-collagen-rich) material by weight and/or at least 10% collagen (constituent, element, or ingredient) by weight, in which the component in final product may be formed into an artificial dehydrated pizzle component having a groove running longitudinally on the surface. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal ear, poultry foot, esophagus, animal pizzle, ligament, pericardium, animal tendon, eggshell membrane, and any combination thereof.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the extruded finned tubular component is formed of a collagen-based composition material having at least 20% collagen-rich (naturally-collagen-rich) material by weight and/or at least 10% collagen (constituent, element or ingredient) by weight, and in which the component in final product may be formed into an artificial dehydrated pizzle component having a groove running longitudinally on the surface. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal ear, poultry foot, esophagus, animal pizzle, ligament, pericardium, animal tendon, eggshell membrane, and any combination thereof.

An embodiment of the present disclosure is to provide a pet chew having an artificial dehydrated pizzle component made of a composition material including animal hide material (which may be rawhide free) and plant-based material, imitating or approximating traditional dehydrated bovine pizzle (traditional bully stick) products which is very much welcome by dogs and their owners.

An embodiment of the present disclosure is to provide a pet chew having an artificial dehydrated pizzle component made of a composition material including collagen material (which may be rawhide free) and plant-based material imitating or approximating traditional dehydrated bovine pizzle (traditional bully stick) products which is very much welcome by dogs and their owners.

An embodiment of the present disclosure is to provide a pet chew having an artificial dehydrated pizzle component made of a composition material including plant ingredient and animal ingredient (typically meat and/or meat-by-products materials) imitating or approximating traditional dehydrated bovine pizzle (traditional bully stick) products which is very much welcome by dogs and their owners.

An embodiment of the present disclosure is to provide a pet chew having an artificial dehydrated pizzle component made of a composition material including pizzle ingredient imitating or approximating traditional dehydrated pizzle (bully stick) products.

### Formula

As aforementioned, the Artificial Dehydrated Pizzle components of a pet chew of the present disclosure may include the following embodiments: 1, mono-layered extrudate to form an Artificial Dehydrated Pizzle component (1.1, a mono-extruded tube hollow inside without stuffings; 1.2, a mono-extruded tube filled with stuffings; 1.3, a mono-extruded sheet rolled up into an Artificial Dehydrated Pizzle shape without stuffings; 1.4, a mono-extruded sheet rolled up into an Artificial Dehydrated Pizzle shape filled with stuffings; 1.5, a mono-extruded (rolled/curved) sheet in an Artificial Dehydrated Pizzle shape without stuffings; 1.6, a mono-extruded (rolled/curved) sheet in an Artificial Dehydrated Pizzle shape filled with stuffings; 1.7, a mono-extruded finned tubular component hollow inside without stuffings; 1.8, a mono-extruded finned tubular component filled with stuffings; 1.9, a mono-extruded cylinder/stick/rod extrudate manipulated or reshaped into final end product configuration); 2, multi-layered extrudate to form an Artificial Dehydrated Pizzle component (2.1, a co-extruded tube with an outer layer and an inner layer; 2.2, a co-extruded extrudate in an Artificial Dehydrated Pizzle shape with an outer layer in a sheet form and an inner layer; 2.3, a co-extruded extrudate in an Artificial Dehydrated Pizzle shape with an outer layer in a finned tubular form and an inner layer; 2.4, a co-extruded cylinder/stick/rod extrudate including a first tubular layer and a second inner layer and manipulated or reshaped into final end product configuration; 2.5, a co-extruded cylinder/stick/rod extrudate with a first segment and a second segment combined which is manipulated or reshaped into final end product configuration). These aforementioned pet chew embodiments can employ any of the formulas (recipes, compositions) described in the formula embodiments as follows as desired if it is applicable.

In some embodiments of the present disclosure, it is to provide an edible pet chew (pet treat) including an artificial dehydrated pizzle component, in which the component is formed of a collagen-based composition material having at least 10% meat ingredient by weight and any one of: at least 20% collagen-rich (naturally-collagen-rich) material by weight, at least 10% collagen (constituent, element or ingredient) by weight and a combination thereof, and in which the component in final product may be formed into an artificial dehydrated pizzle component having a groove running longitudinally on the surface.

In some embodiments of the present disclosure, it is to provide an edible pet chew (pet treat) including an artificial dehydrated pizzle component, in which the component is formed of a collagen-based composition material having at least 25% (more typically at least 30%) collagen (constituent, element or ingredient) by weight in final product, and in which the component in final product may be formed into an artificial dehydrated pizzle component having a groove running longitudinally on the surface.

In some embodiments of the present disclosure, it is to provide an edible pet chew (pet treat) including an artificial dehydrated pizzle component, in which the component is formed of a collagen-based composition material having at least 10% meat ingredient by weight and any one of: at least 30% collagen-rich (naturally-collagen-rich) material by weight, at least 10% collagen (constituent, element or ingredient) by weight and a combination thereof, and in which the component in final product may be formed into an artificial dehydrated pizzle component having a groove running longitudinally on the surface. In some embodiments of the present disclosure, it is to provide an edible pet chew including an artificial dehydrated pizzle component formed of a collagen-based composition material having at least 30% meat ingredient by weight and any one of: at least 30% collagen-rich (naturally-collagen-rich) material by weight, at least 10% collagen (constituent, element, or ingredient) by weight and a combination thereof.

In some embodiments of the present disclosure, it is to provide an edible pet chew (pet treat) including an artificial dehydrated pizzle component, in which the component is formed of a collagen-based composition material having at least 10% meat ingredient by weight, at least 20% plant ingredient by weight and any one of: at least 20% collagen-rich (naturally-collagen-rich) material by weight, at least 10% collagen (constituent, element or ingredient) by weight and a combination thereof, and in which the component in final product may be formed into an artificial dehydrated pizzle component having a groove running longitudinally on the surface.

In some embodiments of the present disclosure, it is to provide an edible pet chew (pet treat) including an artificial dehydrated pizzle component, in which the component is made of a collagen-based composition material having at least 20% plant ingredient by weight and any one of: at least 20% collagen-rich (naturally-collagen-rich) material by weight, at least 10% collagen (constituent, element or ingredient) by weight and a combination thereof, and in which the component in final product may be formed into an artificial dehydrated pizzle component having a groove running longitudinally on the surface. In at least one embodiment of the aforementioned ones, the artificial dehydrated pizzle component is made of a collagen-based composition material having 20%-50% plant ingredient by weight and any one of: at least 50% collagen-rich (naturally-collagen-rich) material by weight, at least 25% collagen (constituent, element, or ingredient) by weight and a combination thereof.

In some embodiments of the present disclosure, it is to provide a pet chew (pet treat) including an artificial dehydrated pizzle component, in which the component is formed of a collagen-based composition material having at least 20% (typically at least 25%, more typically at least 30%) material of corium layer of animal hide (ground form) as the first ingredient (or number one proportion ingredient) by weight in its composition, in which the component in final product may be formed into an artificial dehydrated pizzle component having a groove running longitudinally on the surface.

In some embodiments of the present disclosure, it is to provide a pet chew (pet treat) including an artificial dehydrated pizzle component, in which the component is formed of a collagen-based composition material having at least 10% (typically at least 20%) cartilage material (esp. in ground form) as the first ingredient (or number one proportion ingredient) by weight in its composition.

In some embodiments of the present disclosure, it is to provide a pet chew (pet treat) including an artificial dehydrated pizzle component, in which the pet chew as a whole is a cartilage-based chew containing at least 10% (more typically at least 20%) cartilage constituent (or element, or ingredient) in final end product counting in the cartilage(s) present in every component(s) in which the component in final product may be formed into an artificial dehydrated pizzle component having a groove running longitudinally on the surface.

In some embodiments of the present disclosure, it is to provide a pet chew (pet treat) including an artificial dehydrated pizzle component, in which the component is formed of a composition including any one of: at least 3% by weight meat by-product ingredient(s) that is naturally collagen-rich, at least 3% by weight meat by-product ingredient(s) that is naturally cartilage-rich, at least 3% by weight meat by-product ingredient(s) that is naturally Glucosamine(Chondroitin)-rich and a combination thereof.

In some embodiments of the present disclosure, it is to provide an edible pet chew including an artificial dehydrated pizzle component, in which the component is formed of a (artificial) collagen-based composite/composition material having at least 20% (or 20%-90%) collagen-rich (naturally-collagen-rich) material by weight and/or at least 10% (or 10%-80%) collagen (constituent, element or ingredient) by weight. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal ear, poultry foot, esophagus, animal pizzle, ligament, pericardium, animal tendon, eggshell membrane, and any combination thereof. In an exemplary composition (formula) embodiment of the aforementioned embodiments, the composition (formula) of the collagen-based composition is: Enzymatic hydrolysis processed corium layer of beef skin (55%, classified as naturally-collagen-rich material containing 89% collagen), Corn starch (10%), Pork (3%), Water (11%), Glycerin (15%), Sorbitol (5%) and hydrolyzed chicken liver (1%). As a method for composition interpretation, in this formula, naturally-collagen-rich material (i.e., skin corium layer) occupies 55% of the composition, plant ingredients 10%, meat by-product ingredient 1%, meat 3%. Glycerin and sorbitol may serve as humectants. As yet another method for composition interpretation for the same formula, collagen constituent totally occupies over 49% of the formula (55%*89%+the collagen constituent from pork).

In some embodiments of the present disclosure, it is to provide an edible pet chew including an artificial dehydrated pizzle component, in which the component is formed of a collagen-based composition material having 25%-80% (more typically 30%-80%) collagen (constituent, element or ingredient) by weight in final product.

In some embodiments of the present disclosure, it is to provide an edible pet chew including an artificial dehydrated pizzle component, in which the component is formed of a collagen-based composition material having at least 10% meat ingredient by weight and any one of: at least 20% naturally-collagen-rich material by weight, at least 10% collagen (constituent, element or ingredient) by weight and a combination thereof. Alternatively, the composition may further have 2%-35% humectant (more typically 10%-25% humectants; humectants such as glycerin, sorbitol) ingredients.

In some embodiments of the present disclosure, it is to provide an edible pet chew including an artificial dehydrated pizzle component, in which the component is formed of a collagen-based composition material having at least 10% meat ingredient by weight and any one of: at least 30% naturally-collagen-rich material by weight, at least 10% collagen (constituent, element or ingredient) by weight and a combination thereof. In some embodiments of the present disclosure, it is to provide an edible pet chew including an extruded tubular component formed of a collagen-based composition material having at least 30% meat ingredient by weight and any one of: at least 30% naturally-collagen-rich material by weight, at least 10% collagen (constituent, element, or ingredient) by weight and a combination thereof.

In some embodiments of the present disclosure, it is to provide an edible pet chew including an artificial dehydrated pizzle component, in which the component is formed of a collagen-based composition material having at least 10% meat ingredient by weight, at least 20% plant ingredient by weight and any one of: at least 20% naturally-collagen-rich material by weight, at least 10% collagen (constituent, element or ingredient) by weight and a combination thereof. Alternatively, the composition may further have 2%-35% humectant (more typically 10%-25% humectants; humectants such as glycerin, sorbitol) ingredients. In an exemplary particular formula embodiment, the formula of the composition material is: Ground corium layer of beef skin (20%), Ground corium layer of porcine skin (10%), Wheat flour (25%), Rice (10%), Chicken breast (15%), Glycerin (9%), Sorbitol (2%), Peanut butter (2%, plant ingredient), Fructose (1%), Barley malt syrup (1%), Pork gelatin (2%), Salt (1%), Sodium Tripolyphosphate (0.5%), Potassium sorbate (preservative) (0.2%), Sodium pyrophosphate (0.2%), Xanthan gum (0.5%), Sodium propionate (preservative) (0.2%), Artificial flavoring (0.2%), FD&C Red 40 (0.1%), FD&C Blue 1 (0.05%), FD&C Yellow 6 (0.03%), FD&C yellow 5 (0.02%). In this formula, naturally-collagen-rich ingredient totally occupies 30% (20%+10%) of the formula, plant ingredients 37% (25%+10%+2%) and meat ingredient (15%). Glycerin, sorbitol, sodium tripolyphosphate and sodium pyrophosphate may serve as humectants or chemicals. Fructose, barley malt syrup, pork gelatin, salt, potassium sorbate, xanthan gum, sodium propionate, the flavoring and the colorants may serve as chemicals or additives. Also in this formula, naturally-collagen-rich ingredient totally accounts for at least 25% of the constitution of the artificial dehydrated pizzle component composition (i.e. 30%), and all naturally-collagen-rich material ingredient(s) existing in the “collagen-based” composition added together account for the number one proportion ingredient (i.e. 30%) in the composition by weight, which is larger than any other individual (or single) ingredient (e.g. wheat flour as an individual ingredient) existing in the composition.

In some embodiments of the present disclosure, it is to provide an edible pet chew including an artificial dehydrated pizzle component, in which the component is formed of a collagen-based composition material having at least 20% plant ingredient by weight and any one of: at least 20% naturally-collagen-rich material by weight, at least 10% collagen (constituent, element or ingredient) by weight and a combination thereof. Alternatively, the composition may further have 2%-35% humectant (more typically 10%-25% humectants; humectants such as glycerin, sorbitol) ingredients. In at least one embodiment of the aforementioned ones, the artificial dehydrated pizzle component is formed of a collagen-based composition material having 20%-50% plant ingredient by weight and any one of: at least 50% naturally-collagen-rich material by weight, at least 25% collagen (constituent, element, or ingredient) by weight and a combination thereof.

In an exemplary composition (formula) embodiment of the aforementioned embodiments, the formula of the collagen-based composition is: Tapioca starch (30%), Collagen (25%, extracted collagen from swine bone, classified as collagen constituent), Pig ligament (3%, classified as a source of collagen, containing 80% collagen), Beef trachea (3%, classified as a source of collagen, containing 85% collagen), wheat flour (12%), Beef (3%), Water (12%), Glycerin (11%) and beef liver (1%). In this formula, collagen constituent totally occupies over 29.95% of the formula (25%+3%*80%+3%*85%+the collagen constituent from beef and beef liver), plant ingredients 42%, meat by-product ingredient 1%, meat 3%. Glycerin may serve as an additive or a chemical. In yet another exemplary composition (formula) embodiment of the aforementioned embodiments, the composition (formula) of the collagen-based composition is: Tapioca starch (30%), Ground dermis layer of porcine skin (25%, classified as naturally-collagen-rich material), Pig tendon (3%, classified as naturally-collagen-rich material), Chicken cartilage (3%, classified as naturally-collagen-rich material), wheat flour (12%), Chicken (3%), Water (12%), Glycerin (11%) and beef liver (1%). In this formula, naturally-collagen-rich material totally occupies 31% of the formula (25%+3%+3%), plant ingredients 42%.

In some embodiments of the present disclosure, it is to provide an edible pet chew including an artificial dehydrated pizzle component, in which the edible pet chew has at least 3% UC-II collagen in the formula.

In some embodiments of the present disclosure, it is to provide a pet chew including an artificial dehydrated pizzle component formed of a (artificial) composition material, in which the composition includes Glucosamine constituent (or element, or ingredient) and/or Chondroitin constituent (or element, or ingredient) or a naturally-Glucosamine/Chondroitin-rich material in it.

It is foreseen that rawhide (such as beef rawhide, pork rawhide, esp. in ground form) may be used as an ingredient to form the artificial dehydrated pizzle component while it is involved in health concerns from consumers.

In one embodiment, the Artificial Dehydrated Pizzle (or artificial bully stick, or Pizzle-like) pet chew includes artificial pizzle flavor (or say bully stick flavor) or hydrolyzed pizzle ingredient (this can also provide strong pizzle flavor) in its formula, which further enhances its attraction to dogs and consumers.

In some embodiments of the present disclosure, the outer layer hardness of the Artificial Dehydrated Pizzle (or artificial bully stick) pet chew is with a durometer value between 80 and 100. In other embodiments of the present disclosure, the outer layer hardness of the edible pet chew is with a durometer value between 60 and 80. In other embodiments of the present disclosure, the outer layer hardness of the edible pet chew is with a durometer value between 50 and 60. In other embodiments of the present disclosure, the outer layer hardness of the edible pet chew is with a durometer value between 40 and 50.

The following are referring to formula embodiments that may alternatively form the Artificial Dehydrated Pizzle (or artificial bully stick, or Pizzle-like) pet chew (or pet chew member) of the present disclosure.

Firstly, the phrase of “on an as formulated basis” in the present disclosure that may be used in following paragraphs is defined herein. It is about a means to determine weight percentages of an ingredient in a product. “On an as formulated basis” is also a method that currently FDA (or AAFCO) organizations of USA usually utilize to determine weight percentage for an ingredient in a product. By the means of “on an as formulated basis”, the weight percentage of an ingredient in a food is determined as it is added in the formulation of the food, including its inherent water content, not counting the water added for processing. All weight percentage values of ingredients appearing in the present disclosure apply this “on an as formulated basis” rule.

In one embodiment, the formula of the Artificial Dehydrated Pizzle (or artificial bully stick, or Pizzle-like) pet chew (or pet chew member) of the present disclosure includes a specific meat by-product, pizzle (or animal penis) ingredient. The term of “pizzle ingredient” or “pizzle material” that works as an ingredient to form a composition material forming the artificial bully stick refers to a material derived from animal pizzle, which may be in a form of fresh pizzle, dehydrated pizzle, dried pizzle, ground pizzle, ground dehydrated pizzle, enzymatic pizzle or hydrolyzed pizzle. The advantages of including this specific meat by-products, pizzle ingredient, in the formula go as follows (from point 1 to 4):
1. This product is an extruded (or molded, or injection molding) Artificial Dehydrated Pizzle (or artificial bully stick) pet chew with composition materials intended to imitate the properties of dehydrated bovine pizzle (traditional bully stick) products. A formula with pizzle will make the pet chew not only with a dehydrated bovine pizzle (traditional bully stick) appearance, but also with real bully stick ingredients, where product formula feature is in conformity with product appearance. Selling points of finished products are enhanced by the conformity.
2. Another advantage of applying pizzle ingredient to the Artificial Dehydrated Pizzle (or artificial bully stick) pet chew formula is that, it provides a perfect means to make full use of pizzle leftovers created from genuine bully stick manufacturing industry. A marketable genuine bully stick need be fairly long, for example at least longer than 4″. A bully stick product less than for example 4″ has a jeopardy of dog choking. Most popular bully stick length welcome by consumers is 6″ and 12″. Producing 6″/12″ bully sticks by cutting a pizzle with initial length to desired length certainly generate a lot of small sized pizzle segments. These segments were purchased with a full price but manufacturers did not come up with a method to make good use of them. The Artificial Dehydrated Pizzle (or artificial bully stick) pet chew of the present disclosure can well make use of the pizzle segments by for example grinding them to small piece and having them added to its composition formula.
3. Yet another advantage of applying pizzle ingredient to the Artificial Dehydrated Pizzle (or artificial bully stick) pet chew formula is that, the pizzle ingredient can provide natural pizzle flavor to the pet chew without adding artificial flavors. Natural pizzle flavor is thought to be healthier element than artificial pizzle flavor.
4. Pizzle ingredient is a natural premium protein source for a pet chew product.

In one embodiment, the Artificial Dehydrated Pizzle (or artificial bully stick, or Pizzle-like) pet chew of the present disclosure includes at least 3% pizzle (or animal penis) ingredient in formula. The reason why it has to be with “at least 3%” pizzle ingredients goes as follows (point 1 and 2):
1. “At least 3% pizzle” provides basic inherent attractant attracting dogs to chew on. Per palatability tests conducted by present inventor, this Artificial Dehydrated Pizzle (or artificial bully stick) pet chew with less than 3% cannot provide basic inherent attraction to dogs without aid of other attractant ingredients. “At least 3% pizzle” offering “start point” palatability. We conducted palatability contrast tests to determine the smallest percentage of pizzle ingredient to put into the Artificial Dehydrated Pizzle (or artificial bully stick) pet chew. The test interprets that when the pizzle percentage goes up to 3% or larger than 3%, a jump of number of preferences appears versus plain extruded (or molded, or injection molding) stick chews w/o pizzle ingredient. And the preference is consistent when the pizzle percentage stays at 3% to 10%. Therefore 3% is determined to be the minimum pizzle percentage in the Artificial Dehydrated Pizzle (or artificial bully stick) pet chew.
2. At least 3% pizzle in formula enables product labeling to claim “with pizzle”, or “with real pizzle”, or “with bully stick ingredient” or “with real bully stick” on consumer packages, enhancing product selling points to consumers. A product with less than 3% pizzle cannot indicate “with pizzle” on package labels legally. This is a favorable advantage for the Artificial Dehydrated Pizzle (or artificial bully stick) pet chew product to indicate “with pizzle” as a part of product name which makes the product attractive to consumers (remarks: if the ingredient goes to at least 25%, it will be applied with “dinner” rule in labeling). According to labeling model regulations by AAFCO (the Association of American Feed Control Officials), an ingredient cannot appear as a part of product name or be highlighted on the principal display panel if the ingredient accounts for less than 3% in product formula on an as formulated basis.

In some embodiments, the Artificial Dehydrated Pizzle (or artificial bully stick, or Pizzle-like) pet chew (or pet chew member) includes 3%-50% pizzle ingredient.

In some embodiments, the Artificial Dehydrated Pizzle (or artificial bully stick, or Pizzle-like) pet chew (or pet chew member) includes 5%-65% (more typically 10%-25%) pizzle ingredient on an as formula basis in its formula. The pizzle-like (pizzle-like) pet chew (or pet chew member) with over 50% (especially over 65%) pizzle ingredient is considered too expensive, which could violate the initial intention of introducing this product. Also, The Artificial Dehydrated Pizzle (or artificial bully stick) pet chew (or pet chew member) with over 50% (especially over 65%) pizzle ingredient is considered to be able to ruin the “durability” of the pet chew. The reason is, the more an extruded (or molded, or injection molding) pet chew contains meat (meat by-product), the less durability the extruded (or molded, or injection molding) pet chew will be with. Pizzle is an animal source meat-by-product-ingredient. According to R&D findings by the inventor, 10%-25% pizzle ingredient in the Artificial Dehydrated Pizzle (or artificial bully stick) pet chew (or pet chew member) is an optimal one, which provides a balance between durability, material cost, sufficient inherent natural pizzle flavor and natural protein source.

We conducted palatability contrast tests to determine the starting percentage of pizzle ingredient to put into the Artificial Dehydrated Pizzle (or artificial bully stick) pet chew that can secure an absolute preference for dogs for the pet chew. The test interprets that when the pizzle percentage goes up to 10% or larger than 10%, an absolute preference appears versus plain extruded (or molded, or injection molding) stick chews w/o pizzle ingredient. On the other hand, the more pizzle in a pet chew, the more expensive the pet chew will be. 10%-25% may be a typical pizzle percentage range in the formula or composition of Artificial Dehydrated Pizzle (or artificial bully stick) pet chew that can provide a balance between “palatability” and cost.

In one embodiment, the Artificial Dehydrated Pizzle (or artificial bully stick, or Pizzle-like) pet chew of the present disclosure includes a plant ingredient in the formula. This Artificial Dehydrated Pizzle (or artificial bully stick) pet chew product may be an extruded (or injection-moulding, or cast moulding, or compression moulding) product. Plant ingredient is an often-used material for extruded (or injection-moulding, or cast moulding, or compression moulding) products with advantages of (point 1, 2, 3 and 4):
1. Significantly lower cost than animal ingredients.
2. Provides vegetable nutrition offering a nutrition balance and a healthy diet.
3. Facilitates to make the Artificial Dehydrated Pizzle (or artificial bully stick) pet chew with ideal durability/hardness which enables it to imitate this essential property of traditional bully sticks (dehydrated bovine pizzle). Plants especially plant starch is a good material for extruded (or molded, or injection molding) products which can facilitate the achievement of ideal durability/hardness especially in an extruding (or injection molding) process. A theory explains how it works: When the starch part of plant material is cooked or heated at a particular temperature in extruder or injection molding machine (the temperature is generally >40° C. and what the particular temperature depends on the nature of various types of the starch), heat causes the crystalline regions of the starch to become diffuse, so that the chains begin to separate into an amorphous form. The intermolecular bonds of starch molecules begin to break down. Starch dissolves in water to a sort of paste status. Thus, gelatinization occurs in the starch which offers the durability/hardness property for the pet chew.
4. Can materially imitate a desirable “translucent” outer layer of the Artificial Dehydrated Pizzle (or artificial bully stick) which is a property of traditional (genuine) Bully Stick.

A typical material working as a plant ingredient is plant starch, such as (but not limited to) corn starch, sweet potato, sweet potato starch, tapioca starch and potato starch.

In an embodiment, the Artificial Dehydrated Pizzle (or artificial bully stick) includes at least 20% (for example 20%-90% plant, more typically 20%-50%) plant ingredient in weight on an as formulated basis.

The reasons why it is optimal to be larger than 20% (20% specifically) plant ingredient in the Artificial Dehydrated Pizzle (or artificial bully stick) go as follows: 1. According to our outstanding research tests, 20% plant ingredient appearing in the Artificial Dehydrated Pizzle (or artificial bully stick) formula is the least one that can successfully facilitate recipe to make the Artificial Dehydrated Pizzle (or artificial bully stick) product with ideal durability/hardness which enables it to imitate this essential property of traditional bully sticks (dehydrated bovine pizzle). 2. Recipe with less than 20% plant ingredient fails to do that way with unsatisfactory durability product.

In one embodiment, the Artificial Dehydrated Pizzle (or artificial bully stick, or Pizzle-like) component is typically with a length of about 6″ or 12″, which is considered as most popular stick length welcome by consumers. Diameter of the artificial dehydrated pizzle component could be 1 cm to 5 cm.

In one embodiment, the Artificial Dehydrated Pizzle (or artificial bully stick, or Pizzle-like) pet chew member includes an animal ingredient (including meat and meat by-products) ingredient in the formula.

It should be noted that the “meat” ingredient in the present disclosure is defined as the material selected from (but not limited to) the group consisting of: animal flesh, animal muscle, poultry meat, chicken, chicken breast, duck, goose, turkey, venison, porcine meat, pork, bovine meat, beef, mutton, lamb, goat meat, fish, meat meal, chicken meal, fish meal, hydrolyzed meat protein, hydrolyzed animal material, hydrolyzed animal protein, meat derived ingredient and poultry derived ingredient.

It should also be noted that the “meat by-product” ingredient in the present disclosure is defined as the material typically selected from (but not limited to) the group consisting of: animal pizzle, porcine meat by-product, poultry by-product, bovine meat by-product, animal viscera, animal stomach, animal tongue, animal kidney, animal blood, animal bone, partially defatted low temperature fatty tissue, animal intestines, animal spleen, animal liver, gelatin, animal lung, animal heart, animal pizzle, meat by-product meal, poultry by-product meal, hydrolyzed meat-by-products protein, hydrolyzed meat-by-products material, meat by-product derived ingredient, poultry by-product derived ingredient, animal fat and animal oil. It should be noted that the “meat by-product” in the present disclosure may not optimal to include rawhide material with the reasons of: A, rawhide does not have attractive flavor urging dogs to chew. B, manufacture of rawhide is a relatively unregulated industry. It may create pollution to environment. H2O2 and NaOH chemicals that are used for rawhide manufacture and heavy metals may remain in finished products which harm dogs' health.

Animal ingredient (including Meat and Meat By-products) is an often-used material for extruded (or injection-moulding, or cast moulding, or compression moulding) products with advantages of (point 1 and 2). “Animal ingredient” is defined as edible materials derived from slaughtered mammals. It includes (but not limited to) meat, meat by-products. It does not include hair, horns, teeth and hoofs:
1. Inherent good palatability. Dogs are carnivorous, which have an inherent appetite to eat meat (meat by-product) food. Meat (meat by-product) ingredients in a pet chew works as an attractant providing inherent good palatability for the pet chew.
2. Nutrition. Meat (meat by-product) as a perfect source of animal protein, offering a good nutrition to dogs.

In some embodiments, the Artificial Dehydrated Pizzle (or artificial bully stick, or Pizzle-like) pet chew (or pet chew member) includes 3%-80% (typically 10%-50%) animal ingredient (meat ingredient and/or meat by-products) in its formula on an as formula basis.

The reason why it is optimal to have “at least 3% animal ingredient” goes as follows (point 1 and 2 below):
1. “At least 3% meat (or meat by-product)” provides basic inherent attractant attracting dogs to chew on. Per palatability tests conducted by present inventor, this Artificial Dehydrated Pizzle (or artificial bully stick) pet chew with less than 3% can not provide basic inherent attraction to dogs without aid of other attractant ingredient. “At least 3% meat (meat by-product)” offering “start point” palatability.
2. At least 3% meat (meat by-product) in formula enables product labeling to claim “with meat (meat by-product)” or “with real meat (meat by-product)” on consumer packages, enhancing product selling points to consumers. A product with less than 3% meat (meat by-product) cannot indicate “with meat (meat by-product)” on package labels legally. This is a favorable advantage for the Artificial Dehydrated Pizzle (or artificial bully stick) pet chew product to indicate “with meat (meat by-product)” as a part of product name which makes the product attractive to consumers (remarks: if the ingredient goes to at least 25%, it will be applied with “dinner” rule in labeling). According to labeling model regulations by AAFCO (the Association of American Feed Control Officials), an ingredient cannot appear as a part of product name or be highlighted on the principal display panel if the ingredient accounts for less than 3% in product formula on an as formulated basis.

In one embodiment, in addition to animal ingredient, the Artificial Dehydrated Pizzle (or artificial bully stick, or Pizzle-like) pet chew further includes a chemical in formula. The chemical is introduced to provide the Artificial Dehydrated Pizzle (or artificial bully stick) pet chew sufficient rigidity/durability and strength in finished product. The chemical is selected from the group consisting of a thickener, a humectant, a stabilizer, an emulsifier, a gelatinizer, a binder, and a filler.

The thickener is selected from the group consisting of: glucose syrup, malt syrup, soy protein Isolate, wheat protein isolate, corn protein isolate, artemisia gum, linseed gum, deacetylated chitin, pectins, sodium alginate, xanthan gum, carrageenan; phosphated distarch phosphate, sodium lactate, diacetyl tartaric acid ester of mono(di)glycerides(DATAE), sesbania gum, polyglycerol esters of fatty acid (polyglycerol monostearate, polyglycerol monooleate), maltitol, sorbitol, propylene glycol, ablmoschus manihot gum, β-cyclodextrin, arabic gum, starch acetate, guar gum, potassium alginate, carob bean gum, gellan gum, sodium polyacrylate, distarch phosphate, gelatin, hydroxypropyl, distarch phosphate, hydroxypropyl methyl cellulose, agar, acid treated starch, sodium carboxy methyl cellulose, oxidized starch and oxidized hydroxypropyl starch.

The humectant is selected from the group consisting of: soy protein Isolate, wheat protein isolate, corn protein isolate, glucose syrup, malt syrup, sodium pyrophosphate, trisodium orthophosphate, sodium hexametaphosphate, sodium tripolyphosphate, phosphoric acid, calcium dihydrogen phosphate, sodium lactate, maltitol, sorbitol, propylene glycol, glycerin, sodium dihydrogen phosphate, sodium phosphate dibasic, potassium lactate, sodium lactate, acetylated distarch phosphate and acetylated distarch adipate.

The stabilizer is selected from the group consisting of: trisodium orthophosphate, potassium sorbate, sodium stearoyl lactylate, calcium stearoyl lactylate, phosphoric acid, hydroxypropyl starch, pectins, xanthan gum, carrageenan, sodium lactate, polyglycerol esters of fatty acid (polyglycerol monostearate, polyglycerol monooleate), maltitol, sorbitol, propylene glycol, propylene glycol esters of fatty acid and glucono delta-lactone.

The emulsifier is selected from the group consisting of: soy protein Isolate, wheat protein isolate, corn protein isolate, Sucrose esters of fatty acid, sodium hexametaphosphate, sodium stearoyl lactylate, calcium stearoyl lactylate, hydroxypropyl starch, pectins, carrageenan, diacetyl tartaric acid ester of mono(di)glycerides (DATAE), polyglycerol esters of fatty acid (polyglycerol monostearate, polyglycerol monooleate), maltitol, sorbitan monolaurate, sorbitol, propylene glycol, propylene glycol esters of fatty acid, polyoxyethylene xylitan monostearate, tripolyglyceryl monostearate, potassium stearate, mono-(di-,tri-)glyce rides of fatty acids, modified soybean phospholipid, sodium caseinate, citric and fatty acid esters of glycerol, lactic and fatty acid esters of glycerol, sodium starch octenyl succinate and acetylated mono and diglyceride (acetic and fatty acid esters of glycerol).

The gelatinizer is selected from the group consisting of: soy protein Isolate, wheat protein isolate, corn protein isolate, propylene glycol, glucono delta-lactone.

The binder is selected from the group consisting of: glutinous rice flour, gelatin, linseed gum, pectins, xanthan gum, carrageenan, sesbania gum, maltitol, sodium alginate, ablmoschus manihot gum, arabic gum, guar gum, Carob bean gum, gellan gum and agar.

The filler is selected from the group consisting of: a plant material, a plant derived material, a plant protein and a plant starch, saccharide, dextrin, lactose, mineral salt and fructose.

In some embodiments, the Artificial Dehydrated Pizzle (or artificial bully stick, or Pizzle-like) component of a pet chew of the present disclosure is free of rawhide materials with the concerns of drawbacks of them mentioned in previous paragraph.

It is foreseen that, in some embodiments to form a composition for making the Artificial Dehydrated Pizzle (or artificial bully stick, or Pizzle-like) pet chew, in addition to animal ingredient, rawhide material is used though it is not a encouraged choice. A small percentage of rawhide (for example <20%) may help strengthen the durability of the artificial dehydrated pizzle component. But due to the disadvantages of rawhide material as mentioned in above Paragraphs, rawhide material to be used to form the composition is required to be at a limited percentage by weight. It is anticipated that when rawhide percentage in the composition goes higher than 50%, rawhide material will be an absolute majority ingredients existing in the pet chew formula, which makes the pet chew product a rawhide-based product. A pet chew product made from rawhide-based material is thought to significantly involve in an unhealthy product concern and environment harm concern. Therefore, in some embodiments where rawhide exists in the formula of the Artificial Dehydrated Pizzle (or artificial bully stick) pet chew, it is optimal to have the rawhide material account for less than 50% in weight in its formula. More typically, rawhide material account for 5%-20% in weight in its formula.

In some embodiments of the present disclosure, the Artificial Dehydrated Pizzle (or artificial bully stick, or Pizzle-like) component of a pet chew of the present disclosure includes a plant ingredient (>20%) and an animal ingredient (typically meat or meat-by-products. remarks: meat-by-products includes pizzle) in the formula, forming a pet chew with a texture resembling that of dehydrated bovine pizzle (traditional bully stick) product. All prior arts fail to disclose that plant and animal ingredients with a proper content percentage existing in a composition material can enable the composition material extruded (or molded, or injection molding) sticks to obtain a finished product appearance/texture/rigidity resembling that of dehydrated bovine pizzle (traditional bully stick) product.

In some embodiments of the present disclosure, the Artificial Dehydrated Pizzle (or artificial bully stick, or Pizzle-like) component of a pet chew of the present disclosure includes a hydrolyzed animal protein ingredient and a plant ingredient (>20%) in the formula. The hydrolyzed animal protein (for example hydrolyzed meat protein) works as an attractant in the recipe.

In some embodiments of the present disclosure, the Artificial Dehydrated Pizzle (or artificial bully stick, or Pizzle-like) component of a pet chew of the present disclosure includes a pizzle ingredient and a plant ingredient (>20%) in the formula.

In some embodiments of the present disclosure, the Artificial Dehydrated Pizzle (or artificial bully stick, or Pizzle-like) component of a pet chew of the present disclosure includes a pizzle ingredient, a plant ingredient and a meat ingredient in the formula.

In yet some other embodiments of the present disclosure, the Artificial Dehydrated Pizzle (or artificial bully stick) component of a pet chew of the present disclosure includes a plant ingredient (>20%) and a meat by-products ingredient in the formula.

In an embodiment of the present disclosure, the Artificial Dehydrated Pizzle (or artificial bully stick, or Pizzle-like) component of a pet chew of the present disclosure includes 20%-50% plant ingredient, 10%-50% meat ingredient and a chemical.

In an embodiment of the present disclosure, the Artificial Dehydrated Pizzle (or artificial bully stick, or Pizzle-like) component of a pet chew of the present disclosure includes 0.3%-5% hydrolyzed animal protein ingredient, 20%-90% plant ingredient, 5%-50% meat ingredient and a chemical.

In an embodiment of the present disclosure, the Artificial Dehydrated Pizzle (or artificial bully stick, or Pizzle-like) component of a pet chew of the present disclosure includes 5%-25% pizzle, 50%-90% plant ingredient and a chemical.

In an embodiment of the present disclosure, the Artificial Dehydrated Pizzle (or artificial bully stick, or Pizzle-like) component of a pet chew of the present disclosure includes 3%-25% meat by-products, 50%-90% plant ingredient and a chemical.

In an embodiment of the present disclosure, the Artificial Dehydrated Pizzle (or artificial bully stick, or Pizzle-like) component of a pet chew of the present disclosure includes 5%-25% pizzle, 20%-50% plant ingredient, 10-50% animal hide (source of collagen) ingredient and a chemical.

In one embodiment, the Artificial Dehydrated Pizzle (or artificial bully stick, or Pizzle-like) pet chew is formed by extrusion process with an extruder (either mono-extrusion or co-extrusion). The reasons for a preference of extruding process include: A, Extrusion process can achieve an outer layer texture imitating that of traditional bully sticks (dehydrated bovine pizzle). Extrusion process is viewed as an optimal one. While being extruded, a pressure acts on the composition material which provides durability/texture to finished products; B, It is perfect for producing an extrudate of continuous profile with a uniform cross-section. C, Extruding is a very efficient process, which provides a low-cost processing for making the products; D, It provides large capacity for a single workshop with limited scale. Co-extruding may be a process to produce this pet chew product where co-extruding process can well provide two separate pet chew members (outer layer and inner member) with different quality, which imitates traditional bully sticks (dehydrated bovine pizzle). Now refer to FIG. 13, a drawing of a typical extruder, a machine system for producing pet chew products. The components of the extruder are as follows: 1301—hopper, 1302—reduction gearbox, 1303—power distributor, 1305—screw, 1306—heater, 1307—extruder die and 1308—motor.

In some embodiments of the present disclosure, the artificial dehydrated pizzle component are formed by co-extruding process and the formula forming the outer layer is different from the one forming the inner member. The intention to apply different formulas to the outer layer and the inner member is to achieve different texture, and/or looking, and/or coloring, and/or durability/hardness, and/or density, etc., which could make a one distinguished from the other, imitating or approximating traditional dehydrated bovine pizzle (traditional bully stick) products.

As a process for of the Artificial Dehydrated Pizzle (or artificial bully stick, or Pizzle-like) pet chew in some embodiments of the present disclosure, it includes (from point A to D):
(A). Prepare composition A and B. (Composition A is for forming outer layer of the Artificial Dehydrated Pizzle (or artificial bully stick) pet chew and Composition B is for forming inner member of the Artificial Dehydrated Pizzle (or artificial bully stick) pet chew. At least one of A and B has meat-by-products ingredient (for example pizzle or corium layer of animal hide) ingredient in its formula. The whole pet chew formula may include 20%-70% plant ingredient, 10%-30% meat (meat by-product) ingredient, 30% corium layer of beef hide and 5%-25% pizzle)
(B). Deliver the Composition A and Composition B into a co-extrusion extruder, and heat the compositions in the extruder at a high temperature at least 40° C. or a low temperature lower than 40° C. before their being extruded at the extruder die to a stick form. Extrude the compositions with the extruder.
(C). Divide the extruded stick to pre-determined smaller sized ones with finished pet chew product form.
(D). Dry and harden the product by heating for sufficient time and obtain a final finished dog chew product. Moisture of final finished products is 8%-18%.

Here are some embodiments of the present disclosure with various pet chew shapes/configurations.

Refer to FIG. 4, a pet chew 0400A in a triple-strand braided form is provided according to an embodiment of the present disclosure which is formed of three separate artificial dehydrated pizzle components. The artificial dehydrated pizzle component(s) can be formed in various configurations alternatively as shown per the cross-section profile views 0400B-0400E.

Refer to FIG. 5, two separate pet chews as embodiments according to present disclosure are shown. Pet chew 0500A in a spiral (spring, curl) form is formed from an artificial dried pizzle component having grooves (0501/0502). Pet chew 0500B in a dual-strand braided form which is formed of two separate artificial dehydrated pizzle components, one of which has groove parts (0503/0504). Pet chew 0600A formed of an artificial dehydrated pizzle component in a ring shape from FIG. 6 is provided as an embodiment of the present disclosure. 0600A can be formed with alternative cross-section profile 0602, having a groove part 0601.

The pet chews (0700A/0700B/0700C) from FIG. 7 as embodiments of the present disclosure are in cylindrical form formed from an artificial dehydrated pizzle component prepared by extrusion process. Pet chew 0700A provides comparatively natural appearance in the extrudate with grooves 0701/0702 with the diameter variation through the length. Right after extrusion, the extrudate is in a homogenous diameter and then is manipulated (such as stretching) to take varying treat diameters at different place. 0705 refers to the part that is stretched to thinner. Wrinkles 0703/0704 can be seen there. Similarly, pet chew 0700B and 0700C has a wrinkle 0708 and groove 0706/0707/0709/0710.

The various cross-section profiles 1100A-1100R as shown in FIG. 11 refer to multi-layer extrudate artificial dehydrated pizzle components to form embodiments of the present disclosure, which has grooves 1101-1127. Cross-section profiles 1100A-1100F refer to a co-extruded artificial dehydrated pizzle component having two layers attached to each other firmly, outer layer of which is in a tube form. 1100G-1100L refer to a co-extruded artificial dehydrated pizzle component having two layers attached to each other firmly, outer layer of which is in a finned tubular form. 1100M-1100R refer to a co-extruded artificial dehydrated pizzle component having two layers attached to each other firmly, outer layer of which is in a curved sheet form.

The various cross-section profiles 1200A-1200R as shown in FIG. 12 refer to mono-layer extrudate artificial dehydrated pizzle components to form embodiments of the present disclosure, which has grooves 1201-1227. Cross-section profiles 1200A-1200F refer to a co-extruded artificial dehydrated pizzle component having two layers attached to each other firmly, outer layer of which is in a tube form. 1200G-1200L refer to a co-extruded artificial dehydrated pizzle component having two layers attached to each other firmly, outer layer of which is in a finned tubular form. 1200M-1200R refer to a co-extruded artificial dehydrated pizzle component having two layers attached to each other firmly, outer layer of which is in a curved sheet form.

In some embodiments of the present disclosure, an Edible Material member is applied together with a member of Artificial Dehydrated Pizzle (or artificial bully stick) component, where the edible material member and the Artificial Dehydrated Pizzle (or artificial bully stick) member are assembled together to form a pet chew.

In some embodiments of the present disclosure, a member of animal hide (a source of collagen) may be applied together with a member of Artificial Dehydrated Pizzle (or artificial bully stick), where the animal hide member and the Artificial Dehydrated Pizzle (or artificial bully stick) member are assembled together to form a pet chew. Now refer to FIG. 10 an edible pet 1000 is created with a member of Artificial-Bully-Stick 1000 and an animal hide member 1011 assembled together.

In yet some embodiments of the present disclosure, a member of Genuine Animal Pizzle material may be applied together with a member of Artificial Dehydrated Pizzle (or artificial bully stick) component, where the Genuine animal Pizzle material member and the Artificial Dehydrated Pizzle (or artificial bully stick) member are assembled together to form a pet chew.

As a formula embodiment to form the composition to produce the Artificial Dehydrated Pizzle (or artificial bully stick, or Pizzle-like) component, the composition is consisting of: Corium layer of beef hide (37.2%), Rice flour (30%, classified as plant ingredient), vegetable glycerin (8%), gelatin (7%), fresh chicken breast (5% classified as meat ingredient), ground bovine tendon (3%, classified as meat-by-products ingredient), cellulose powder (2%, classified as plant ingredient), calcium carbonate (2%), sweet potato (2%, classified as plant ingredient), lecithin (1%), carrageenan gun (1%), hydrolyzed pizzle (0.5% classified as meat-by-products ingredient), brewers yeast (0.5%), titanium dioxide (0.4%), FD&C yellow 6 (0.2%), FD&C red 40 (0.1%), FD&C blue 1 (0.1%). In this formula, meat-by-products ingredient occupies 3.5% in the formula, collagen material totally 47.2% (naturally-collagen-rich material 40.2%), plant ingredient totally 34%, and meat 5%. Vegetable glycerin, calcium carbonate and carrageenan gum are some chemicals.

As another formula embodiment to form the composition to produce the Artificial Dehydrated Pizzle (or artificial bully stick, or Pizzle-like) component, the composition is consisting of: Turkey tendon (20%), Rice flour (23.6%, classified as plant ingredient), fresh chicken breast (30%, classified as meat ingredient), vegetable glycerin (8%), gelatin (7%), chicken cartilage (2% classified as meat ingredient), cellulose powder (2%, classified as plant ingredient), calcium carbonate (2%), sweet potato (2%, classified as plant ingredient), lecithin (1%), carrageenan gum (1%), brewers yeast (1%), titanium dioxide (0.4%). In this formula, plant ingredient occupies totally 27.6% in the formula, and meat totally 32%. Collagen material occupies totally 29% (20%+7%+2%), of which turkey tendon and chicken cartilage are classified as naturally-collagen-rich materials. Vegetable glycerin, calcium carbonate and carrageenan gun are some chemicals.

As another formula embodiment to form the composition to produce the Artificial Dehydrated Pizzle (or artificial bully stick, or Pizzle-like) component, the composition is consisting of: Fresh chicken breast (28.00%, classified as meat ingredient), tapioca starch (20.00%, classified as plant ingredient), ground pizzle (12.00%, classified as pizzle ingredient), dermis layer of porkhide (12.00%), vegetable glycerin (8.00%), dermis layer of beefhide (5.00%), sorbitol (3.60%), cellulose powder (3.00%, classified as plant ingredient), calcium carbonate (3.00%), sweet potato (2.00%, classified as plant ingredient), lecithin (1.00%), carrageenan gum (1.00%), brewers yeast (1.00%), titanium dioxide (0.40%). In this formula, pizzle ingredient occupies 12% in the formula, meat 28% and plant ingredient totally 25%. Collagen-rich material occupies 17% (12%+5%). Vegetable glycerin, sorbitol, calcium carbonate and carrageenan gun are some chemicals.

One skilled in the art will understand that the embodiment of the present disclosure as shown in the drawings and described above is exemplary only and not intended to be limiting.

What is claimed is:

1. An edible pet chew, comprising:
an artificial dried pizzle component for imitating a dried animal pizzle product, wherein said artificial dried pizzle component is in a form imitating a dried animal pizzle product shape,
wherein said artificial dried pizzle component comprises a groove longitudinally on its surface, and
wherein said artificial dried pizzle component is formed from a composition material, wherein said composition material comprises at least 10% collagen by weight.

2. The edible pet chew, as recited in claim 1,
wherein said composition material is a collagen-based composition material, and
wherein said composition material comprises at least 10% collagen by weight.

3. The edible pet chew, as recited in claim 1,
wherein said composition material is a cartilage-based composition material, and
wherein said composition material comprises at least 10% cartilage ingredient by weight in formula.

4. The edible pet chew, as recited in claim 2,
wherein said composition material comprises at least 25% collagen by weight, and
wherein said collagen is selected from the group consisting of: a collagen molecule, a collagen chemical, a natural collagen supplement, a synthetic collagen supplement, a collagen peptide, a gelatin, a hydrolyzed collagen and any combination thereof.

5. The edible pet chew, as recited in claim 2,
wherein said composition material comprises at least 20% or at least 30% naturally-collagen-rich material, and
wherein said naturally-collagen-rich material is selected from a group consisting of: cartilage, trachea, animal ear, poultry foot, esophagus, animal pizzle, ligament, pericardium, animal tendon, corium layer of animal skin, dermis layer of animal skin, innermost layer of animal skin, inner layer of animal skin, eggshell membrane and any combination thereof.

6. The edible pet chew, as recited in claim 5,
wherein said composition material comprises at least 50% naturally-collagen-rich material, and
wherein said naturally-collagen-rich material is selected from a group consisting of: cartilage, trachea, animal ear, poultry foot, esophagus, animal pizzle, ligament, pericardium, animal tendon, corium layer of animal skin, dermis layer of animal skin, innermost layer of animal skin, inner layer of animal skin, eggshell membrane and any combination thereof.

7. The edible pet chew, as recited in claim 1, wherein said artificial dried pizzle component is an extrudate formed by an extrusion process.

8. The edible pet chew, as recited in claim 7, wherein said extrudate is any one of: a tubular extrudate having a groove longitudinally on its surface, a sheet extrudate having a groove longitudinally on its surface, a finned tubular extrudate having a groove longitudinally on its surface, a cylindrical extrudate having a groove longitudinally on its surface, a rod-shaped extrudate having a groove longitudinally on its surface and a stick-shaped extrudate having a groove longitudinally on its surface.

9. The edible pet chew, as recited in claim 7,
wherein said artificial dried pizzle component is formed from a sheet extrudate, and
wherein said sheet extrudate is shaped into a curved sheet or rolled sheet form creating a groove longitudinally on its surface.

10. The edible pet chew, as recited in claim 1,
wherein said artificial dried pizzle component comprises an outer layer portion and an inner portion,
wherein said outer layer portion is formed from a sheet extrudate,
wherein said sheet extrudate is shaped into a curved sheet or rolled sheet form having a groove longitudinally on its surface, and
wherein said inner portion is an edible material serving as a stuffing positioned into said outer layer portion.

11. The edible pet chew, as recited in claim 1,
wherein said artificial dried pizzle component is made of an extrudate having an outer layer portion and an inner portion formed by co-extrusion,
wherein said outer layer portion is formed of a first composition, and
wherein said inner portion is formed of a second composition.

12. The edible pet chew, as recited in claim 1,
wherein said artificial dried pizzle component is manipulated or shaped into a final end product configuration, wherein said final end product configuration is selected from a group consisting of: a knotted bone form, a twisted stick form, a ring form, a spiral form, a spring form, a curl form, a pretzel knot form, a knotted form, a kabob form, a dural-strand braid form, a triple-strand braid form, a stick and a braid form.

13. The edible pet chew, as recited in claim 1, wherein a cross section of said artificial dried pizzle component is in a shape similar to capital letter B, Arabic numeral 8, peanut icon, cashew nut icon or heart icon.

14. The edible pet chew, as recited in claim 1,
wherein said composition material further comprises an animal pizzle ingredient in its formula, and
wherein said composition material is free of rawhide.

15. The edible pet chew, as recited in claim 7, wherein said artificial dried pizzle component has at least two holes inside running through a length of said artificial dried pizzle component.

16. The edible pet chew, as recited in claim 1, wherein said artificial dried pizzle component has a plurality of bubbles inside spread into a body of said artificial dried pizzle component.

17. The edible pet chew, as recited in claim 1, wherein said composition material further comprises an animal ingredient, wherein said animal ingredient is a meat or meat by-product ingredient.

18. The edible pet chew, as recited in claim 1,
wherein said composition material further comprises 20%-90% or at least 50%-90% plant ingredient by weight on an as formulated basis in the formula, and
wherein said plant ingredient is an ingredient selected from the group consisting of vegetables, fruit, edible-plant-derived materials, vegetable-derived materials, fruit-derived materials, plant protein, vegetable protein, plant starch, vegetable starch, grains, cereals, corn, sweet potato, gluten-free edible plant, and gluten-free vegetables.

19. The edible pet chew, as recited in claim 1, wherein said composition material further comprises an animal hide ingredient, wherein said composition material comprises 20%-50% said plant ingredient by weight on an as formulated basis and 10%-50% said animal hide ingredient by weight on an as formulated basis.

20. The edible pet chew, as recited in claim 7, wherein said composition material further comprises a chemical, wherein said composition material comprises 10%-50% said meat or 10%-50% said meat by-product ingredient on an as formulated basis in the formula by weight;
wherein said meat ingredient is selected from the group consisting of: animal flesh, animal muscle, poultry meat, chicken, chicken breast, duck, goose, turkey, venison, porcine meat, pork, bovine meat, beef, mutton, lamb, goat meat, fish, meat meal, chicken meat, fish meat, hydrolyzed meat protein, hydrolyzed animal material, hydrolyzed animal protein, meat derived ingredient, and poultry derived ingredient,
wherein said meat by-product ingredient is selected from the group consisting of: animal pizzle, porcine meat by-product, poultry by-product, bovine meat by-product, animal viscera, animal stomach, animal tongue, animal kidney, animal blood, animal bone, partially defatted low temperature fatty tissue, animal intestines, animal spleen, animal liver, animal lung, animal heart, meat by-product meal, poultry by-product meal, hydrolyzed meat-by-products protein, hydrolyzed meat-by-products material, meat by-product derived ingredient, poultry by-product derived ingredient, gelatin, animal fat, and animal oil.

21. The edible pet chew, as recited in claim 1, further comprising:
an edible material member, wherein said artificial dried pizzle component and said edible material member are assembled together to form a final product.

22. The edible pet chew, as recited in claim 21, wherein said edible material member is one or more of: an animal hide material, an animal pizzle material, a cartilage, a trachea, an animal ear, an esophagus, a ligament, a pericardium, an animal tendon, corium layer of animal skin, dermis layer of animal skin, innermost layer of animal skin and inner layer of animal skin.
